(19) United States
(12) Patent Application Publication
(10) Pub. No.: US 2003/0126090 A1
(43) Pub. Date: Jul. 3, 2003

(54) Conversation method, device, program and computer-readable recording medium on which conversation program is recorded

(75) Inventors: Toshiyuki Fukuoka, Kawasaki (JP); Ryosuke Miyata, Kawasaki (JP); Koichi Murakami, Kawasaki (JP); Eiji Kitagawa, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/330,304

(22) Filed: Dec. 30, 2002

Related U.S. Application Data
(63) Continuation-in-part of application No. 10/124,374, filed on Apr. 18, 2002.

(30) Foreign Application Priority Data
Dec. 28, 2001 (JP) 2001-400675
Nov. 14, 2002 (JP) 2002-331193

(51) Int. Cl. G06F 17/60; H04K 1/00

(52) U.S. Cl. 705/54

(57) ABSTRACT

a) Predicting, by conversation information, context patterns that can possibly occur in future, evaluating the predicted context patterns according to the rating criteria, b) selecting a system message which is to be output next among a highly evaluated context pattern, and outputting the system message, c) selecting at least one user message that is among the user messages correspond to the system message and that is included in the conversation information, and outputting the user message, d) accepting selection of any one of the user message, e) deciding the next position of a marker that shows current topic according to the selected user message, f) repeating the step a) to e).

### RELATED APPLICATIONS

This is a continuation-in-part of application Ser. No. 10/124,374, filed Apr. 18, 2002.

### BACKGROUND OF THE INVENTION

1. Technical Field

The present invention relates to technology by which fellow business users who operate computers have conversations with the computers to sell, search for, and inquire about merchandise or services for their customers.

2. Description of Related Art

Various conversation systems are offered as systems that let users utilizing computers sell, search for, and inquire about merchandise or services. Most of these conversation systems are configured so that they can respond to user input, such as question input and designation of options. A general way to respond to user input is to search for a response using the user's input as a key.

Meanwhile, game systems are offered as systems that let users have conversations with computers. In such conversations, a user answers in response to a question from a computer by designating an option or solving a riddle. This kind of conversation is possible under the condition that options by which a user answers in response to the questions from a computer are limited and context patterns are previously stored in the computer. Each context pattern is a possible scenario that consists of series of questions from the computer and options for answering the questions.

When a conversation system responds to an instance of user input using the input as a key, the conversation between the user and the conversation system basically ends after the user-input instance and the system's response to it. Even if the conversation system accepts another user-input instance and likewise responds, there will be no relationships among the separate combinations of user-input instances and the system's respective responses. Accordingly, this kind of conversation system cannot conduct conversations that have contextual qualities, as do those between humans. Moreover, the content of the conversation tends to be rather boring for a user who is in a conversation with the system. This is because the conversation is led by the user's input, and the content of the output from the conversation system is passive. Meanwhile, considering such conversation as that in the above-mentioned game systems—conversation based on preset options for users to answer—the longer the preset conversation grows, the more complex its structure will become. This results in severe limits on a user's answering options, lack of variety in the options, and repetition of similar conversations.

In short, a conversation system that conducts conversations having a contextual character and that performs effective information exchange has not been offered. If such a conversation system could lead the conversation to a specific result, the system could be effectively utilized for searching or inquiring about merchandise or services through a computer.

### SUMMARY OF THE INVENTION

An object of the present invention is for conversation utilizing a computer to provide technology in order to conduct natural conversations between the computer and a user. Another object of the present invention is for conversation utilizing a computer to provide technology that is effective in, for example, selling, searching for, and inquiring about merchandise or services.

The invention in a first aspect is a conversation method for conducting conversations between a computer and a user who operates the computer. This method includes: a topic-net storing step of storing a topic net linking a plurality of topics; a conversation-information storing step of storing conversation information including at least one system message that is a message from the computer, at least one user message that is a message from the user and that corresponds to the system message, and a correspondence between a position in the topic net and the system message and/or the user message; a messaging step including a sub-step of creating potential context patterns based upon a position in the topic net of a first marker indicating a current topic in the conversation, a sub-step of selecting at least one context pattern from the created context patterns, a sub-step of selecting a system message based upon the selected context pattern and outputting it; an option outputting step including a sub-step of selecting at least one user message based upon the position in the topic net correspondent to the selected system message, and a sub-step of outputting the selected user message; a selection accepting step of accepting selection of any one of the selected user messages; a decision making step of deciding the first marker's next position in the topic net; and an iterating step of iterating said messaging step, said option outputting step, said selection step, and said decision making step.

This conversation method executes the conversation by moving marker(s) in the topic net and outputting system messages corresponding to the topic net. An output system message is decided by selecting one of context patterns that can occur in the future and that are predicted based on the marker's current position. To give an example of a way of selecting a system message: rating all context patterns, selecting the most highly rated context pattern, and selecting a system message that should be output next in the context pattern.

Another aspect of the invention is the conversation method as set forth in the forgoing first aspect, wherein the method further including: a link joining any given first topic and any given second topic within the topic net defines a first direction heading from the first topic to the second topic, and a second direction heading from the second topic to the first topic.

In this method, a topic net, for example, a topic net utilizing for searching merchandise or inquiring about merchandise, preferably has node structure. In this node structure, nodes are linked and form tree shape widening from the beginning side of the conversation (upstream-end) into the ending side of the conversation (downstream-end). In this kind of a topic net, upstream-end nodes indicate generic or overall topics compared to downstream-end nodes. Conversely, downstream-end nodes indicate more specific or special topics compared to upstream-end nodes. Nevertheless, the link directionality is not limited to being prescribed by the direction in which a conversation using the topic net proceeds. That is, a conversation may proceed along the direction of a link, or may proceed going reverse to the link.

Another aspect of the invention is the conversation method as set forth in the forgoing first aspect, wherein the method further including: a marker creating step of creating a second marker at any position in the topic net, wherein the second marker is independent of the first marker; a conversation executing step of executing at least two conversational exchanges on each of the first marker and the second marker, by executing said messaging step, said option outputting step, said selection accepting step, said decision making step, and said repeating step.

Second and third topics are generated by creating further markers. For the topic corresponding to each marker, an in-context set of conversational exchanges is executed independently. Several conversational-exchange sets may be alternately executed, or may be executed simultaneously. In this way, natural conversation, like conversation between humans, is executed in such a way that the conversation diverges from its original topic and converges back to it again, lending it a natural context.

To give an example of a way of creating the second marker, creating the second marker in the case two context patterns are selected among the created context patterns may be cited. Separately executing two sets of conversational exchanges sometimes results in that each marker for the conversational-exchange sets converges at the same position in the topic net. This means each topic of the conversational-exchange sets becomes the same. Two sets of conversational exchanges converge, i.e., they are merged into one in this case, preferably.

To give another example of the method of creating the second marker, accepting an instruction of creation from the user may be cited. For example, suppose that travel destination and travel purpose are selected as topics by a user in a case in which the user wants to search for a travel package to suit for his/her taste. Then, two markers are created, and two conversational exchanges about the topics corresponding to the markers are executed.

A preferable aspect of the invention is the conversation method in the forgoing first aspect, wherein the conversation information further includes at least one message type showing the classification of a system message or the classification of a user message, wherein: said messaging step creates the context patterns based upon message types; and said option outputting step outputs a user message whose message type meets the system message's message type, the user message among the user messages corresponding to the system message.

To give examples of message types, assertive explanation, normal explanation, specific free question, proposal, user's agreement, user's denial, user's selection may be cited. Taking message type into account avoids combining a certain system message with a user message that a user will not select for the response to the system message when the context patterns are created. For example, a user message whose message type is user's agreement or user's denial is not combined with a system message whose message type is specific free question. Likewise, among the user messages corresponding to a system message that is to be output, the user messages whose message types are not appropriate for the system message are not output as options for the user.

Another aspect is the conversation method said forth in the forgoing first aspect, wherein the method further includes: a criteria storing step of storing a rating criteria for evaluating the context patterns; and said messaging step evaluates created context patterns according to the rating criteria and selects at least one context pattern based upon the rating results.

The following are examples of rating criteria wherein several rules are predetermined and points are given to the context pattern if it satisfies with a rule.

Rule 1: if conversation has been lead to an aimed topic under the condition that the total number of system messages and user messages in the conversation is ten or less, then twenty points are given to a context pattern.

Rule 2: if four or more system messages are consecutively output based on the same marker, then six points are given to a context pattern.

Rule 3: if at least two markers are merged into one in a context pattern, then it is given five points.

Finally at least one context pattern is selected based upon total points. The context pattern having the highest total points may be selected. However, the method of selecting the context pattern(s) is not limited for this method. For example, a plurality of context patterns may be selected in the case there is a narrow difference in their total points.

A rating criterion may be, to name a preferable example, such that the repeated output of the same system message is avoided. A conversation method adopting this rating criterion further includes a log-storing step of storing a past-outputted system message. Furthermore, the messaging step evaluates the created conversation patterns according to the rating criterion and selects that conversation pattern for which system messages redundant over past-outputted system messages are small. Doing so means that the same questions and comments will not be repeated to the user; and this enables natural conversations to be conducted.

A rating criterion may be, to name a different preferable example, such that it controls the marker count to be a given amount or less. A conversation method adopting this rating criterion further includes the following steps. The messaging step in this method evaluates the created context patterns according to the rating criterion, and selects a context pattern for which its marker total count does not exceed a threshold value.

A second marker creating step of newly creating at least one second marker in any given position on the topic net; and

A second multi-conversation executing step of executing, with regard to each of the first marker and the second marker(s), the messaging step, the option outputting step, the selection accepting step, the deciding step, and the iterating step.

That the markers increase means that the user is engaged in conversation on a number of topics at the same time. Too many topics leads to the risk that the user will not be able to remember by him or herself the content of the dialogues on all the topics, and the conversation will end up breaking apart. It is thus preferable to set an upper limit to the number of topics that proceed at once, and to encourage convergence of the dialogues.

A rating criterion may be, to name a different preferable example, such that it strikes a balance between user message time and message time on the system end. In a conversation method adopting this rating criterion, the messaging step evaluates the created context patterns according to the rating criterion, and selects a context pattern for which a balance is struck between system-message quantity and user-message quantity. Too great a quantity of system messages leads to passive dialogue for the user, and interest wanes. By the same token, the quantity of information offered to the user turns out to be too little. Selecting a context pattern in which a balance is struck between the two realizes natural, enjoyable dialogues.

A rating criterion may be, to name a different preferable example, such that it avoids topics that the user dislikes. A conversation method adopting this rating criterion further includes a prohibited-topic assigning step of assigning to a topic within the topic net a prohibited-topic variable indicating that the user does not like that topic. Also, the topic-net storing step stores correlatively with that conversation topic the prohibited-topic variable assigned in the prohibited-topic assigning step. And further, the messaging step rates the created context patterns according to the rating criterion, and selects a context pattern not containing the prohibited topic that is the topic the user does not like. Prohibited topics might for example be inferred from user messages that a user has selected.

Likewise for example, a prohibited-topic variable may be assigned to each topic within the topic net, and prohibited topics inferred based on the prohibited-topic variables. A value may for example be assigned to a prohibited-topic variable based on a user message that the user has selected. Likewise for example, significance levels indicating how significant the topics that the nodes on the topic net represent are for a user, and conviction levels indicating how sure the significance levels are may be utilized as prohibited-topic variables.

A rating criterion may be, to name a different preferable example, such that it selects a context pattern based on the significance levels. A conversation method adopting this rating criterion further includes a significance-level assigning step of assigning, correlatively to the topics in the topic net, significance levels indicating how important the user views each of the topics in the topic net as being. Also, the conversation-information storing step further stores, correlatively with the topics, the significance levels assigned in the significance-level assigning step. In addition, the messaging step selects a context pattern based on the significance levels for the topics contained in the created context patterns, and on the rating criterion. Dialogues that are interesting for a user presumably may be held by outputting system messages that go along with context patterns that contain topics that the user feels are important. A significance level might be a value that is inputted by a user, or might be a conveyed value, wherein a value inputted by a user is run along a link on the topic net.

A rating criterion, to name a different preferable example, may be one that selects a context pattern based on the significance and conviction levels. A conversation method adopting this rating criterion further includes a variable-assigning step of assigning, correlatively to the topics within the topic net, significance levels indicating how important the user views each of the topics in the topic net as being, and conviction levels indicating how certain are the significance levels. Also, the conversation-information storing step further stores, correlatively with the topics, the significance levels and conviction levels assigned in the variable-assigning step. Furthermore, the messaging step selects a context pattern based on the significance and conviction levels for the topics contained in the created context patterns, and on the rating criterion. A conviction level could, for example, be high with respect to a significance level which has been inputted by a user, and could be low with respect to a significance level through conveyance along a link on the topic net. User interest in topics is presumably high if the significance and conviction levels for the topics are together high. Selecting context patterns including topics of this sort allows dialogues to be conducted along the lines of a user's tastes and interests.

A rating criterion, to name a different preferable example, may be one that prioritizes dialogues according to new topics. A conversation method adopting this rating criterion includes the following second marker creating step, updating step, and second multi-conversation executing step. Also, the messaging step selects a context pattern based on the significance and conviction levels for the topics contained in the created context patterns, and on the rating criterion.

A second marker creating step of newly creating at least one second marker in any given position on the topic net;

An updating step of monitoring elapsed time since creation of the markers and deleting markers for which a given amount of time has elapsed, and updating significance levels and/or conviction levels for topics relevant to the deleted markers, or else without deleting markers for which a given amount of time has elapsed, updating significance levels and/or conviction levels for topics relevant to the markers; and

A second multi-conversation executing step of executing, with regard to those remaining of either the first marker or the second marker(s), the messaging step, the option outputting step, the selection accepting step, the deciding step, and said iterating step.

Significance and conviction levels for topics in connection with an old marker are downgraded. Because the significance and conviction levels for topics in connection with new markers grow higher, context patterns built on new markers are preferentially selected.

A rating criterion, to name a different preferable example, may be one that restricts the number of times that a dialogue switches the direction in which it proceeds. In a conversation method adopting this rating criterion a link joining any given first topic and any given second topic within the topic net indicates a first direction heading from the first topic to the second topic, and a second direction heading from the second topic to the first topic. In addition, the messaging step evaluates the created context patterns according to the rating criterion, and selects a context pattern for which the movement of the first marker does not frequently switch over between the first direction and the second direction.

If the direction a dialogue is heading switches frequently between, for example, generalizing and individualizing, there would be a concern that with a poor flow, the dialogue would end up developing insufficiently. Dialogue development can be encouraged by selecting the dialogues so as to avoid context patterns of this sort.

A rating criterion, to name a different preferable example, may be one that prioritizes topics newly entered into the topic net. In a conversation method adopting this rating criterion, the conversation-information storing step further stores time it has passed since the conversation information was stored correlated with the topic net. In addition, the messaging step evaluates the created context patterns according to the rating criterion, and selects a context pattern for which the movement of the first marker does not frequently, at a predetermined rate or more, switch over between the first direction and the second direction. Executing context patterns that include new dialogue information makes hot conversations based on fresh information possible.

A rating criterion, to name a different preferable example, may be one that selects a context pattern based on how trustworthy its topics are. In a conversation method adopting this rating criterion the conversation-information storing step further stores date and time the conversation information was correlated with the topic net. Likewise, this conversation method further includes an elapsed-time computation step of timing the current date and time, and computing time elapsed from the stored date and time to the current date and time. In addition, the messaging step rates the created context patterns according to the rating criterion, and selects a context pattern containing a topic correlated with conversation information for which the elapsed time is the shorter.

This method can guide a user to a topic involving a data enterer whose reliability is believed to be high. If for example topics that have been entered by data enterer A are included among topics touched upon in past dialogues, then a context pattern including a topic that data enterer A has entered would be selected. A further example that may be given is, in a situation in which data enterer B, who is world-famous, has entered part of the dialogue information concerning the topic “wine” contained in one of the created context patterns, selecting that context pattern.

A rating criterion, to name a different preferable example, may be one that guides a user in a direction in which topics are abundant. In a conversation method adopting this rating criterion, the messaging step rates the created context patterns according to the rating criterion, and selects a context pattern for which the number of system messages included in the context pattern is the greater. By leading the user in a direction in which system messages are abundant, dialogues rich in changes can be realized.

In yet another preferred embodiment, provided is a conversation method in which the messaging step creates context patterns made up of system messages and user messages, wherein system-message and user-message total count is a predetermined number n or more.

The predetermined number n (positive integer) is not particularly limited, but the larger the n the greater the increase in the number of context patterns, and the larger the context-pattern creation burden grows. On the other hand, too small a value of n, makes conducting a legitimate context pattern rating problematic. Preferably the value of n is appropriately established taking these two aspects, and topic-net complexity, into consideration.

A separate embodiment of the present invention provides a conversation device for conducting dialogues between a computer and a user who operates the computer. The conversation device includes following means.

A topic net storing means for storing a topic net linking a plurality of topics;

A conversation information storing means for storing conversation information including at least one system message being a message from the computer end, at least one user message being a message from the user end vis-a-vis the system message, and a correspondence between a position in the topic net and the system message and/or the user message;

A messaging means for creating, based upon a position in the topic net of a first marker showing a current topic in the conversation, context patterns able to arise, selecting at least one context pattern from among the created context patterns, and based upon the selected context pattern selecting a system message, and outputting it;

An option outputting means for selecting at least one user message based upon the position in the topic net corresponding to the selected system message, and outputting the selected user message;

A selection accepting means for accepting selection of any selected user message;

A decision making means for deciding the first marker's next position in the topic net; and

An iterating means for iteratively causing the messaging means, the option outputting means, the selection accepting means and the decision making means to function.

A different embodiment of the present invention provides a computer conversation product for conducting dialogues between a computer and a user who operates the computer. The computer product causes the computer to function as the foregoing conversation device.

Yet a different embodiment of the present invention is a computer-readable recording medium on which is recorded a conversation program for conducting dialogues between a computer and a user who operates the computer. This conversation program executes the conversation method set forth in the forgoing first aspect of the invention.

The recording medium herein may be, to name some examples, a flexible disc, a hard disk, semiconductor memory, a CD-ROM, a DVD, a magneto-optical disc (MO), or another computer-read/writeable recording medium.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a configuration of the conversation system in a first embodiment example;

FIG. 2 is an explanatory diagram showing an example of the topic net;

FIG. 3 is an explanatory diagram showing an example of a conversation log;

FIG. 4 is an explanatory diagram showing a continuation of the conversation log in FIG. 3;

FIG. 5 is an explanatory diagram showing details from the topic net in FIG. 2;

FIG. 6 is an explanatory diagram showing an example of conversation information correlated with the topic “Italy” in the topic net of FIG. 5;

FIG. 7 is an explanatory diagram showing an example of conversation information correlated with the “Italy→Rome” link in the topic net of FIG. 5; FIG. 8 is an explanatory diagram showing an example of conversation information correlated with the topic “Rome” in the topic net FIG. 5;

FIG. 9 is an explanatory diagram of a topic net in which a plurality of markers is established;

FIG. 10 is a display example of system messages, user messages, and a conversation log;

FIG. 11 is an example of a screen for accepting selection of topic by a user;

FIG. 12 is an explanatory diagram indicating how context patterns are created;

FIG. 13 is an explanatory diagram showing some examples of context patterns;

FIG. 14 is an explanatory diagram showing an example of rating criteria;

FIG. 15 is an explanatory diagram indicating rating results according to the rating criteria in FIG. 14;

FIG. 16 is a flowchart illustrating the flow of a conversation-executing routine;

FIG. 17 is an explanatory diagram showing a different example of rating criteria;

FIG. 18 is an explanatory diagram in which the progress direction along a context pattern switches over in upstream/downstream directions;

FIG. 19 is an explanatory diagram representing fresh markers being created in a context pattern;

FIG. 20 is an explanatory diagram of conversation device functions in a separate embodiment example;

FIG. 21 is an explanatory diagram of a topic net in which significance and conviction levels have been set;

FIG. 22 is an explanatory diagram representing conveyance of significance and conviction levels;

FIG. 23 is an explanatory diagram representing conveyance and superimposition of significance and conviction levels;

FIG. 24 is an explanatory diagram representing conveyance and superimposition of significance and conviction levels;

FIG. 25 is a conceptual explanatory diagram of a topic net DB in which entry date/time and enterer are stored;

FIG. 26 is an explanatory diagram representing an example of a topic net; and

FIG. 27 is an explanatory diagram representing a separate example of a topic net.

### DETAILED DESCRIPTION OF THE PREFERRED EMBODIMENTS

Overall Configuration

In the present invention, conversation between a computer and a user who operates the computer is performed. Herein, a “topic net” comprises a plurality of topics, a plurality of links connecting topics, and topic IDs for identifying each topic. If a topic net with the aim of searching for merchandise is established, the topics indicate subjects relating to the merchandise such as characteristics of the merchandise, keywords for searching for the merchandise, and the like. More concretely, if a topic net with the aim of searching for travel packages is established, the topics in the topic net are destination, travel purpose, travel time, and the like. A link connecting two topics expresses an upstream-end/downstream-end relationship.

The conversation method in the present invention conducts conversations by utilizing, in addition to the topic net, rating criteria and conversation information pertaining to the topic net. The conversation method in the present invention is summarized as follows.

1) Predicting, from conversation information, context patterns that can possibly occur in the future, evaluating the predicted context patterns according to the rating criteria, selecting a system message which is to be output next from a context pattern with a high rating, and outputting the system message;

2) Selecting at least one user message that is among the user messages corresponding to the system message and that is included in the conversation information, and outputting the user message;

3) Accepting selection of any one of the user messages;

4) Deciding according to the selected user message the next position of a marker that indicates the current topic; and

5) Repeating steps 1 through 4.

Herein, a “system message” is a message from the computer to the user. A “user message” is an option that a user can select as a response to a system message.

### FIRST EMBODIMENT EXAMPLE

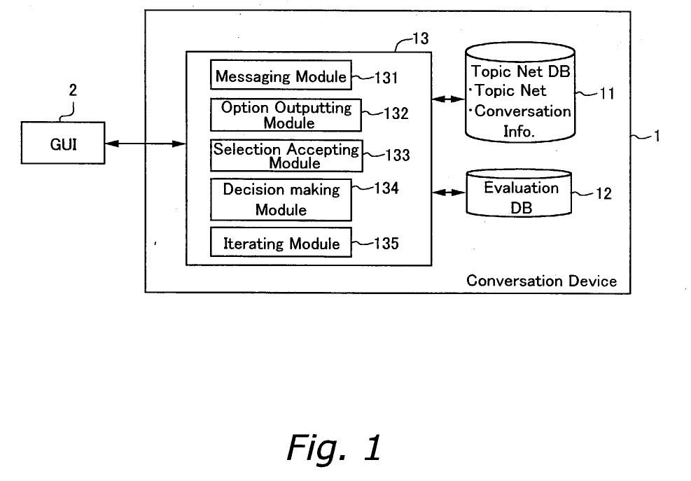

Next, the first embodiment example of the present example will be explained. In this embodiment, conversation utilizing a topic net is executed between a conversation system shown in FIG. 1 and a user who operates it. FIG. 1 is a block diagram illustrating the functional configuration of the conversation system. The conversation system includes a conversation device 1 and a GUI (Graphical User Interface) 2. The conversation device 1 may be actualized by a computer. On the hard disk of the conversation device 1, a topic net database (topic storing means) 11, a rating criteria database 12 (criteria means) are stored. The topic net DB 11 stores a topic net and conversation information. The rating criteria DB 12 stores rating criteria for evaluating context patterns that can occur in the future. These databases may be stored on the hard disk of a computer with which the conversation device 1 can communicate. The CPU in the conversation device 1 functions as a control unit 13. The control unit 13 includes: a messaging module 131 that is an example of messaging means; an option outputting module 132 that is an example of option outputting means; a selection accepting module 133 that is an example of selection accepting means; a deciding module 134 that is an example of decision making means; and an iterating module 135 that is an example of repeating means.

The GUI 2 may be actualized by a computer. A computer may function as the conversation device 1 and the GUI 2, or each of different computers may function as the conversation device 1 and the GUI 2. The GUI 2 displays system messages, user messages, and conversation logs. Following is a detailed explanation of the conversation system. Firstly, the basic concept behind conversation utilizing the topic net will be explained;

secondly how to a conversation is conducted will be explained. Details of the conversation system will be given in these explanations.

(1) Basic Concept Behind Conversation Utilizing Topic Net

(1-1) Topic Net

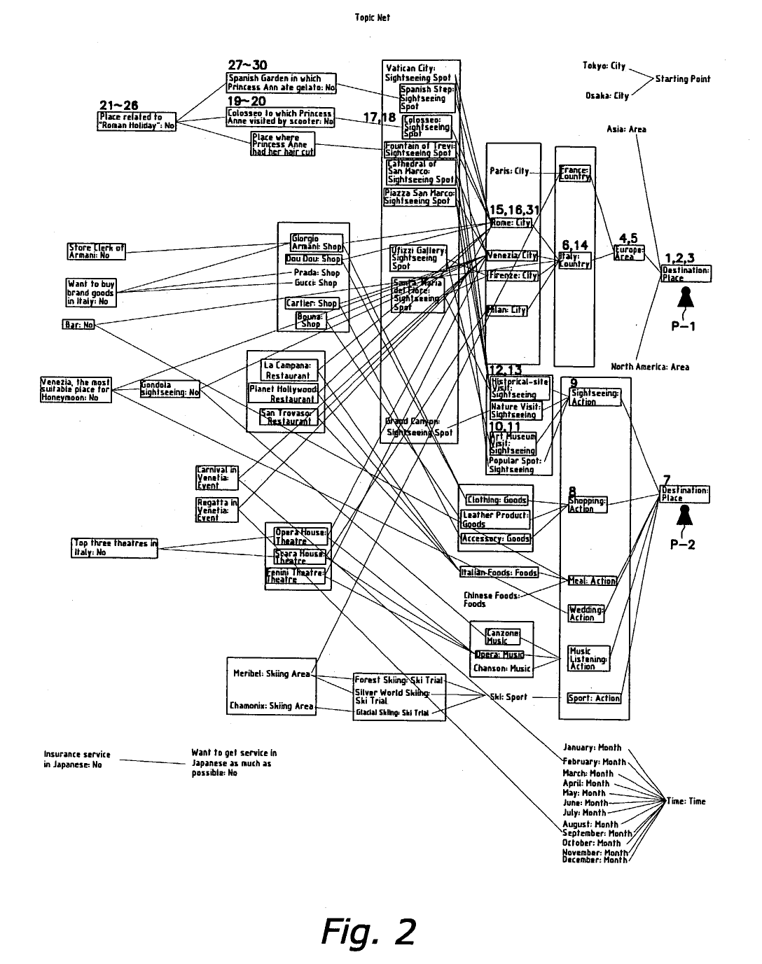

FIG. 2 is an explanatory diagram showing an example of a topic net stored in the topic net DB 11. The topic net is created according to the aim for which it is used and category of merchandise such as searching for or inquiring about merchandise. The topic net in this example is in the aim of planning travel itineraries suitable for users. In this topic net, each node is linked so that the topic net forms a tree structure widening from upstream to downstream. That is, given any first and second nodes joined by a link, the first node will be on the upstream end of the second node, and the second node will be on the downstream end of the first node. However, links in some topic nets do not define an upstream-end/downstream-end orientation. The orientation of the links, and the direction in which a dialogue progresses, may coincide or just as well may not coincide. Likewise, the topic net may be a tree structure that widens from downstream to upstream, or may simply be nodes joined together by links, without being formed in a tree structure. At least one marker is established in the topic net by the deciding module 134 in the control unit 13. Each marker corresponds to a node, and indicates the current topic in each set of conversational exchanges. Two markers, P-1 and P-2, are set in the topic net in FIG. 2. The markers will be described later.

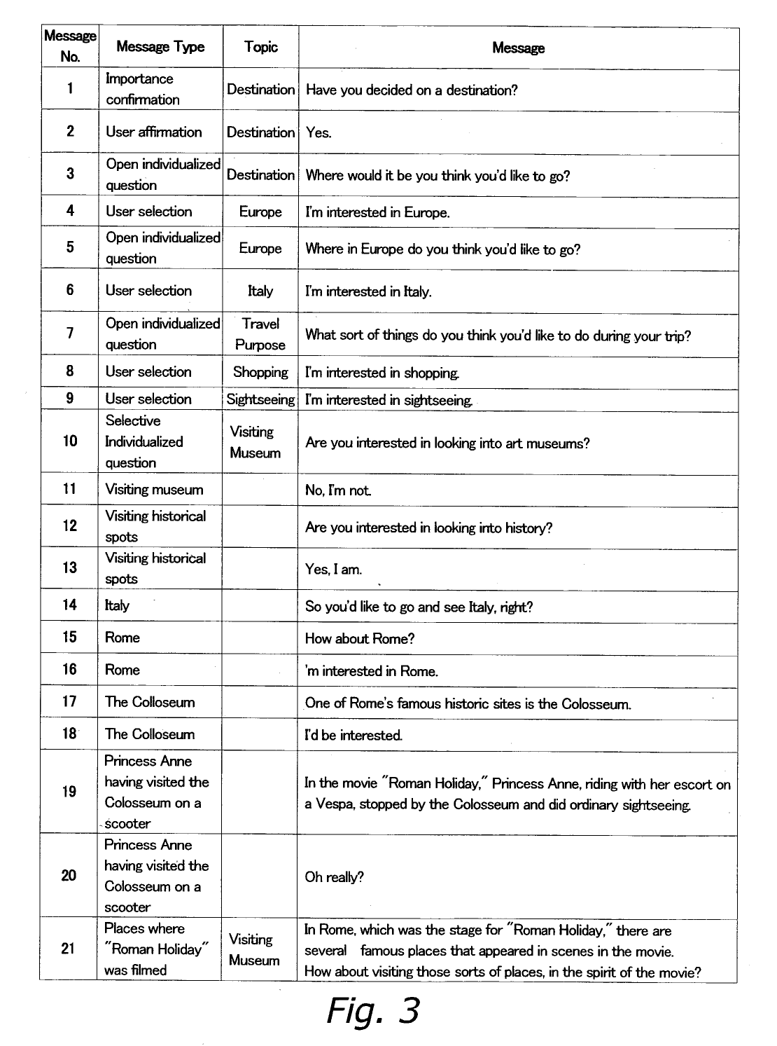

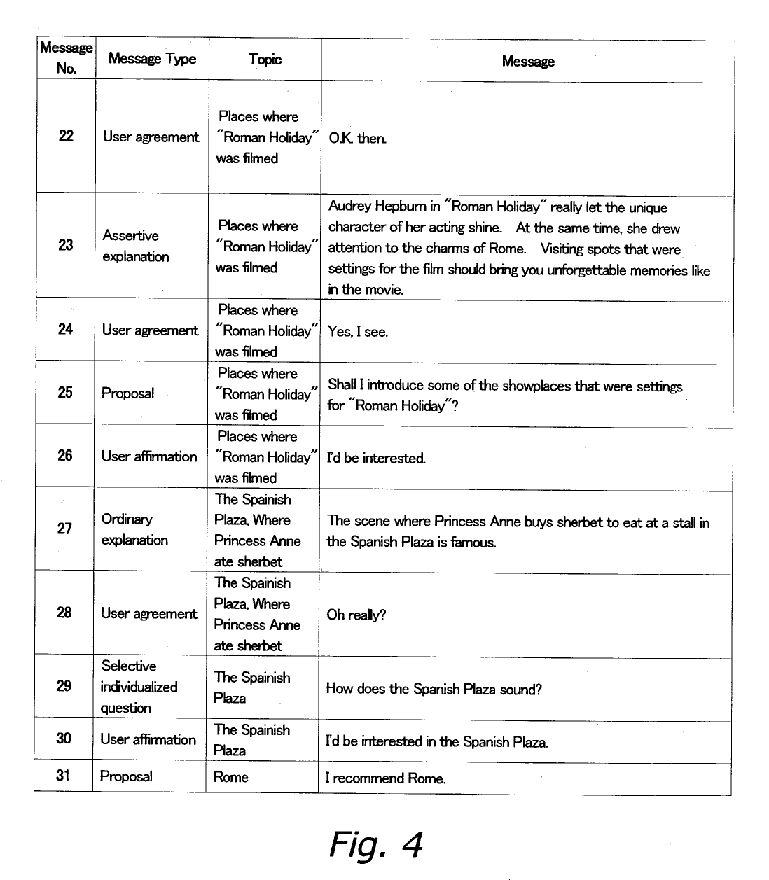

FIGS. 3 and 4 illustrate an example of log of a conversation that has been conducted according to the topic net described in FIG. 2. The conversation log is temporally stored in an operational memory such as a RAM (not shown in the figure), and is output on GUI 2. The conversation log may be stored on the hard disk in the conversation device 1, or on other recording media. The conversation log in these figures sets out a conversation performed in order to plan a user's travel destination. A conversation transition from “destination,” which is the upstream-end topic, to “Rome,” which is the downstream-end topic, is shown in this conversation log. It may be said that a comprehensive topic, destination, converges to the more specific topic in the conversation. It will be appreciated that in some instances a dialogue will proceed from the downstream end to the upstream end, with an eye toward realizing naturalness in the dialogue and also, depending on how the topic net is put to use.

The conversation log may include not only messages in the conversation but other information. Herein it contains a message number, which is a serial number that is assigned to each of the messages in the conversation. The conversation log also includes a message type for each message and topic. The message type is attribute information indicating message classification, and is set in the conversation information. The topic corresponds to a node that a marker is indicating. In other words, changes of topics in the conversation log represent the marker's topic-net movement in the conversation.

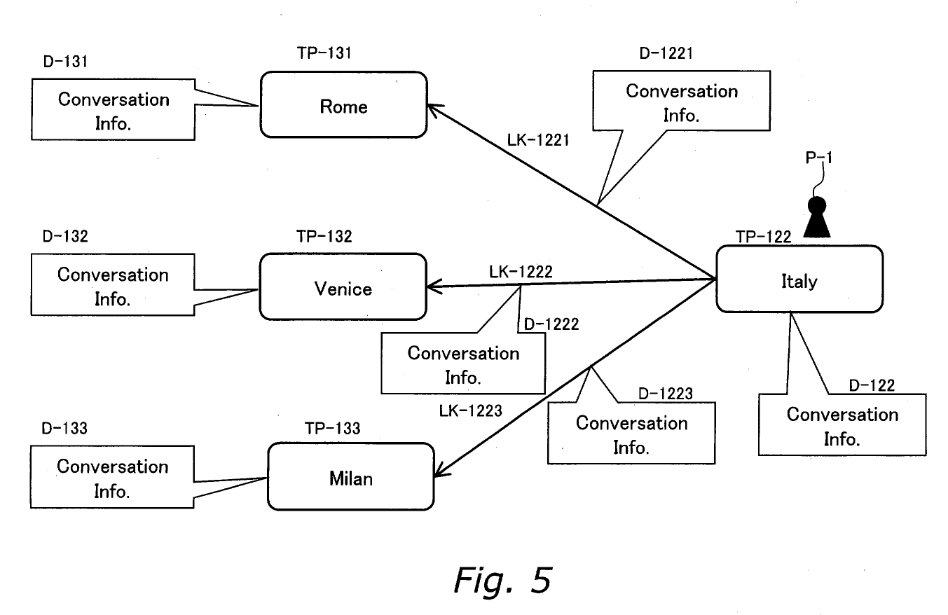

FIG. 5 is an explanatory diagram showing details from the topic net of FIG. 2. A part of the topic net in FIG. 2 is enlarged here. Each node in the topic net is identified by the topic ID (node identifier) “TP-131,” “TP-132,”. . . . Each node corresponds to a topic.

Each link is identified by a link ID (link identifier) “LK-122,” “LK-1222,” . . . . A link connects two topics and defines which one is the upstream-end and which one is the downstream-end. For instance, in FIG. 5, topic TP-122 and topic TP-131 are linked by link LK-1221. This link defines a direction from the topic “Italy” to the topic “Rome.” The upstream-end topic indicates a more comprehensive topic or a more generic topic compared to a downstream-end topic. On the other hand, a downstream-end topic indicates a more specific topic or a more concrete topic compared to an upstream-end topic. Connecting each node by links that have directions configures the topic net in a tree structure widening from the upstream-end to the downstream-end.

Conversation information that contains system messages and/or user messages is stored correlatively with each node and each link, although conversation information corresponding to a link may be stored correlatively with the node from which the link originates. A marker P-1, which indicates a topic corresponding to a current topic in a conversation, is set in the topic net. The marker P-1 moves along the links over the topic net according to progress of conversation. System messages and user messages are output on the GIU2 based on conversation information for nodes on which the marker P-1 is located, or conversation information for links originating from the nodes.

In the topic net, if topic A is linked with topics B, C . . . that are located downstream from topic A, topic A signifies a topic that is more comprehensive than topics B, C . . . and that is common to those topics B, C . . . . For instance, topic TP-122 “Italy” is linked to topic TP-131 “Rome,” topic TP-132 “Venice” and topic TP-133 “Milan,” which are more specific than the topic “Italy.” The topic “Italy” is common to “Rome,” “Venice,” and “Milan” and expresses a place that comprehends these three cities.

Conversely, if topic A is linked with topics B, C . . . that are located upstream from topic A, then topic A signifies a topic that is more specific than those of topics B, C . . . and that is common to those of topics B, C . . . . For instance, the topic “The Colosseum” is linked with the topics “Rome” and “visiting historical spots” that are on the upstream-end. The topic “The Colosseum” is common to “Rome” and “visiting historical spots,” and expresses a more specific or more concrete place than the other topics.

The above-mentioned topic net is not limited that in illustrated FIG. 2. The topic net is prepared according to the merchandise or services, and might be, for example a topic net for designing a travel plan, a topic net for searching for a personal computer suitable for a user, or a topic net for preparing a wedding party. The topic net DB 11 stores at least one topic net.

(1-2) Conversation Information

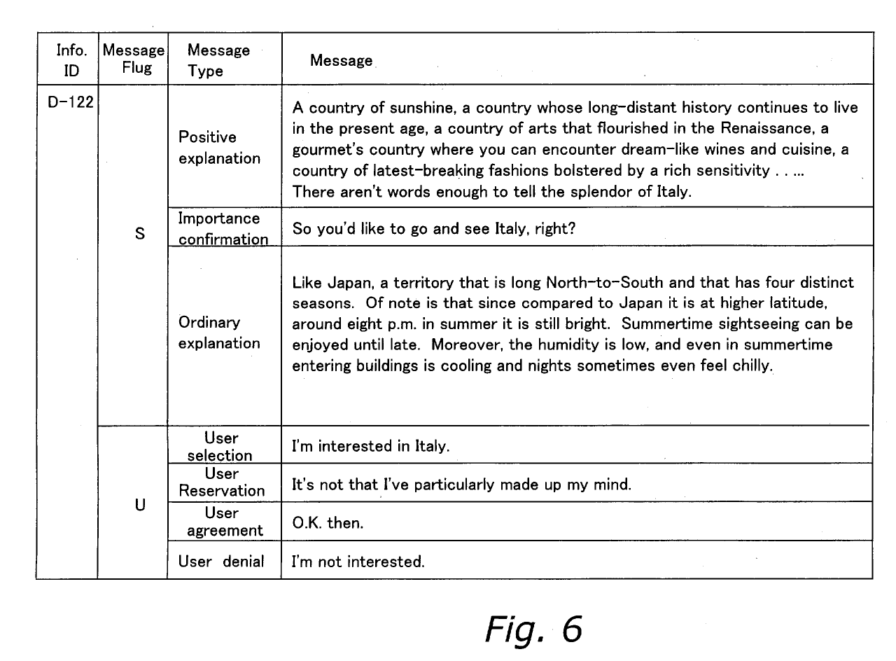

FIGS. 6, 7, and 8 illustrate explanatory diagrams of conversation information stored in the topic net DB 11. The conversation information is generated so that it is related to a node or a link in the topic net. The conversation information shown in these figures are examples of conversation information for the topic net on FIG. 5.

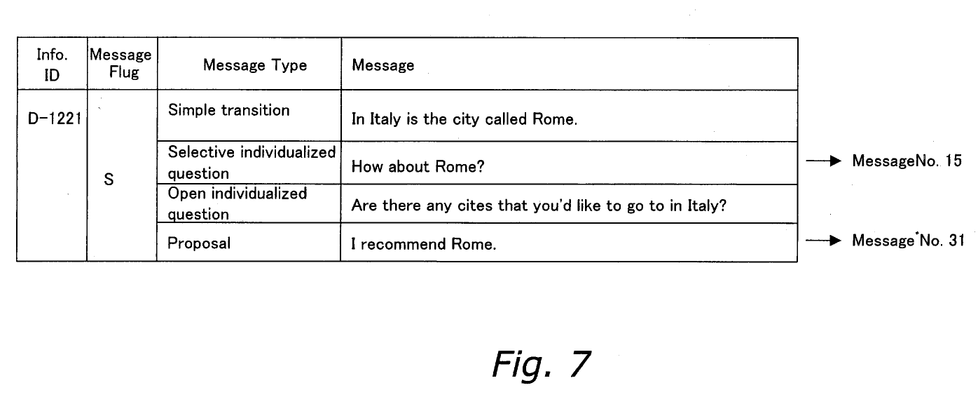

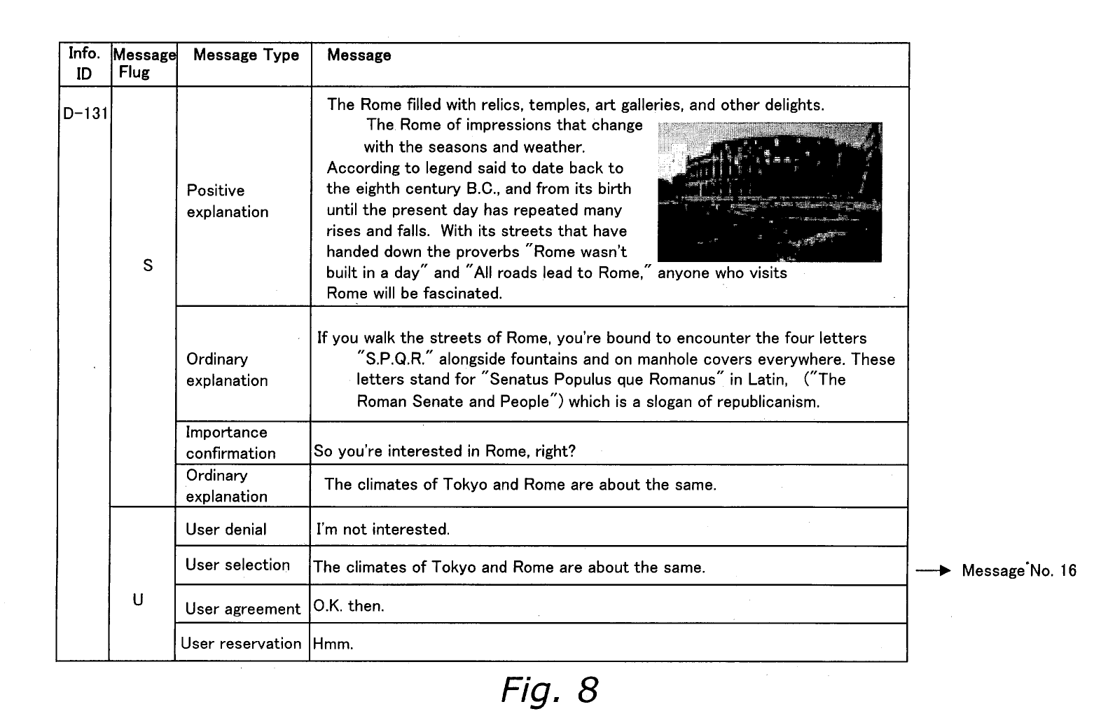

FIG. 6 sets forth conversation information correlated to node TP-122 (topic “Italy”). FIG. 7 sets forth conversation information correlated to link LK-1221 from the topic “Italy” to the topic “Rome.” FIG. 8 sets forth conversation information correlated to node TP-131 (topic “Rome”).

In these examples, conversation information is identified by an information ID. Each item of conversation information includes a message flag, a message type, and a message. A message flag is a flag that shows whether the message corresponding to the message flag is a system message from the system end or a user message as an option for the user. The message flag is not necessary in the case in which a judgment as to whether the message is a system message or user message can be made according to the message type.

The “message type” indicates the category of message, such as explanation, confirmation, agreement, denial, or selection. The message type is information that is not always necessary; however, it is preferably contained in the conversation information, since it is utilized for evaluating context patterns based on the rating criteria, which will be discussed in section 2-2. In the present embodiment example, the message types for system messages are presumed to be “positive explanation,” “important explanation,” “importance confirmation,” “ordinary explanation,” “simple transition,” “selective individualized question,” “open individualized question,” and “proposal.” Among these seven message types, “positive explanation,” “importance confirmation,” and “ordinary explanation,” in particular are message types that indicate properties of messages relating to contents of topics, and may be treated as message types that are included in a node's conversation information. The other four message types—i.e., “simple transition,” “selective individualized question,” “open individualized question,” and “proposal”—may be treated as message types that are contained in a link's conversation information, since these message types pertain to transition of topic. For example, node TP-233 (topic “Italy”) and node TP-131 (topic “Rome”) are related to conversation information that contains system messages having three node types. Link LK-1221 from “Italy” to “Rome” is correlated to conversation information that contains system messages having four link types. Of course, a plurality of messages may have the same message type in conversation information that is correlated to a node or a link.

In addition, four message types for user messages are presumed in the present embodiment example. They are “user selection,” “user reservation,” “user agreement,” and “user denial.” Hereinafter these message types are referred as “user types.” A user message is contained in a node's conversation information and not contained in a link's conversation information in the present embodiment. For example, the user messages in the conversation information for nodes TP-122 and TP-131 (“Italy” and “Rome”) contains all user types. However, the conversation information for link LK-1221 from “Italy” to “Rome” does not contain any user message. Any user message in response to this link's system messages is selected from user messages contained in conversation information correlated with link destination node TP-131 (topic “Rome”). Of course, a link's conversation information may include a user message.

Messages in conversation information are text messages for displaying as system messages, or are text messages for displaying as options in response to system messages. A message may contain not only a text message but also an image file, a voice file, a link to these kinds of files, or the like. For instance, the system message in the conversation information for “Rome” in FIG. 8 contains image data for sightseeing spots in Rome. Likewise, a system message for a node relating to a topic “concert ticket” may for example include audio data or image files of musicians performing programs the tickets are for.

(1-3) Marker Position and Displayed Message

A conversation using a topic net develops according a marker's movement in the topic net. As mentioned above, at least one marker is set on a node by the deciding module 134 in the control unit 13. A marker moves from node to node along the direction of a link in the present embodiment. A system message and a user message that are to be displayed change in accordance with the position of the marker in the topic net. FIG. 5 is referred to again to explain the relation between the position of a marker and a system message and a user message that are to be displayed.

A system message that is to be displayed is selected from the conversation information for a node on which a marker is located, or the conversation information for a link which originates form the node. For example, in FIG. 5, marker P-1 is located on node TP-122 (“Italy”). In this case a system message that is to be displayed is selected from conversation information items D-122, D-1221, D-1222, and D-1223 that are correlated to the node, or from three links originating from the node, and is displayed. The selection and the control of the display are executed by the messaging module 131.

A user message displayed as an option in response to the selected system message is part or all of the user messages contained in conversation information D-122, in the case in which the system message is selected from the node's conversation information D-122. If the system message is selected from the conversation information for one of the links, the user message is part or all of the user messages contained in the conversation information for the link destination node. For example, suppose that the system message is selected from conversation information D-1221 for link LK-1221, which is from “Italy” to “Rome”. In this case, at least one user message is selected from conversation information TP-131 that is correlated to the link destination node TP-131 (“Rome”).

One of the methods of selecting at least one user message in order to display it as an option is to select all of the user messages contained in conversation information D-131. However, another method is to select user messages whose user message type suits the selected system message. Examples of suitable combinations of message types that may be cited include: (1) in response to a “selective question” system message, selecting and displaying user messages that can answer the question; and (2) in response to an “explanation” system message, selecting user messages expressing such responses as user's agreement, denial, or not being able to understand. The responses herein are expressed by such user messages as “I see,” “I don't think so,” “I don't know.”

If a link's conversation information contains both system messages and user messages, user messages displayed in response to system messages can be selected from the link's user messages and/or the link destination node's user messages. Selecting and displaying at least one user message is controlled and executed by the option outputting module 132.

When any one of displayed user messages is selected by the user, the marker moves to the node whose conversation information contains the selected user message. The selection of a user message is accepted by the selection accepting module 133. Markers are moved by the deciding module 134.

(1-4) Pluralities of Markers and Marker Merging

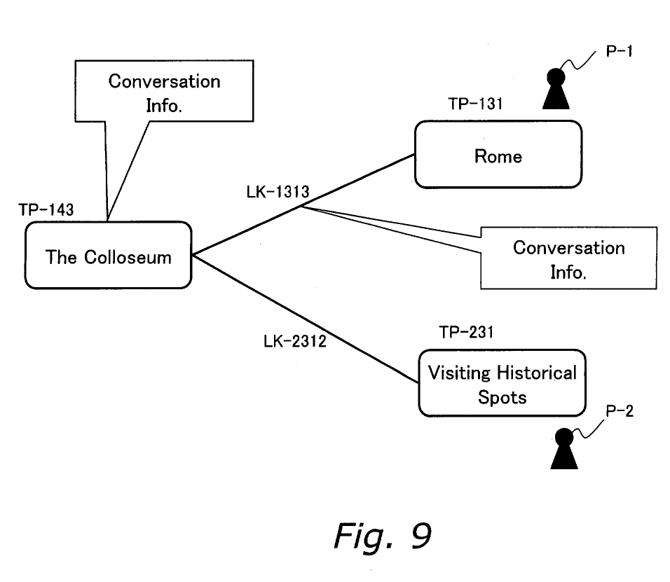

FIG. 9 is an explanatory diagram showing a plurality of markers in the topic net and merging of the markers. The number of markers set in the topic net is not limited to one. A plurality of markers may be set in a topic net by the deciding module 134 in the control unit 13 generating second and third markers. Each position of each marker indicates how much the set of conversational exchanges has developed along the subjects indicated by the marker.

Suppose that marker P-1 (a first marker) is set on the topic “destination” and that marker P-2 (a second marker) is set on the topic “travel purpose” in FIG. 2. In this case, the first set of conversational exchanges develops from the subject “destination,” while the second set of conversational exchanges develops separately from the subject “travel purpose.”

FIG. 9 shows a situation in which two conversational-exchange sets are developing. In FIG. 9, marker P-1 (the first marker) is located on node TP-131 (topic “Rome”). This marker P-1 has moved from the topic “destination” (see FIG. 2) to the topic “Rome.” Meanwhile, marker P-2 (the second marker) is located on node TP-231 (topic “visiting historical spots”). This marker P-2 has moved from the topic “travel purpose (see FIG. 2) to the topic “visiting historical spots.” In this way, two conversational-exchange sets develop separately according to independent movements of the two markers. As a result, the computer can conduct a natural conversation like between human beings, in which topics deviate from each other or jump back and forth, and a natural contextual flow is created.

Several conversational-exchange sets developing separately sometimes converge into one. This happens when a plurality of markers moves to the same node in the topic net. For example, suppose that a user selects the user message “I'm interested in The Colosseum” in response to the system messages displayed in accordance with marker P-1 being located on node TP-131 (topic “Rome”). Then, marker P-1 moves to node TP-143 (topic “Colosseum”). Meanwhile, suppose that the user selects the user message “I'm interested in The Colosseum” in response to the system message displayed in accordance with marker P-2 being located on node TP-231 (topic “visiting historical spots”). Then, marker P-2 moves to node TP-143 (topic “The Colosseum”). The two markers P-1 and P-2 move to the same node TP-143 (topic “The Colosseum”) and merge into one marker. As mentioned above, the deciding module 134 merges a plurality of markers into one when these markers move to the same node in the topic net. This results in convergence in the conversation and makes it easier to lead the conversation to a conclusion.

(1-5) Conversation Display Examples

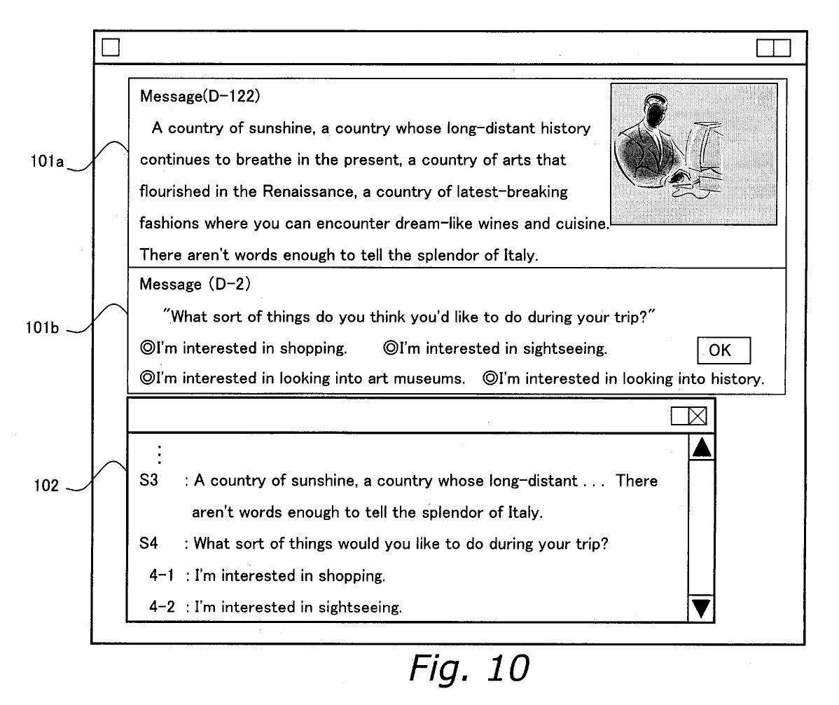

FIG. 10 is a display example of a conversation as displayed by the GUI 2. The messages are selected by the messaging module 131 and the option outputting module 132, and are displayed on the display by the GUI 2. This example illustrates a situation in which two markers are set in the topic net and two sets of conversational exchanges are developing. Message windows 101a, 101b are displayed on the display. Each message window is created in order to display each conversational-exchange set according to each marker. In FIG. 10, message window 101a illustrates a system message whose message type is “ordinary explanation.” Message window 101b illustrates a system message whose message type is “open individualized question,” and user messages that are suitable for answering in response to the system message. The user would select at least one user message in this example.

Log window 102 is also displayed on the display. Log window 102 shows a log of a conversation conducted between the user and the conversation system (see FIGS. 3 and 4).

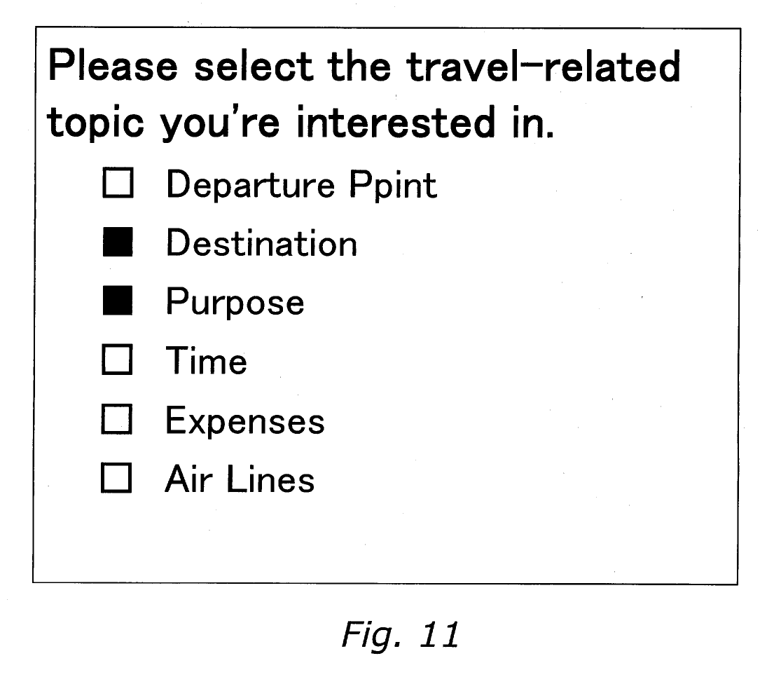

FIG. 11 shows an example of a screen for accepting selection of topics by a user. This screen is displayed at the beginning of a conversation, and accepts selection of one or a number of subjects. Herein, the two subjects “destination” and “travel purpose” have been selected. After selection of the subjects, a number of message windows that is the number of selected subjects are displayed, and the sets of conversational exchanges proceed. The selection of subjects is accepted by the deciding module 134. Alternatively, the conversation device 1 can select the subjects before the conversation starts.

(2) Method for Developing Conversation

A method for developing conversation utilizing the topic net will be explained with reference to the drawings.

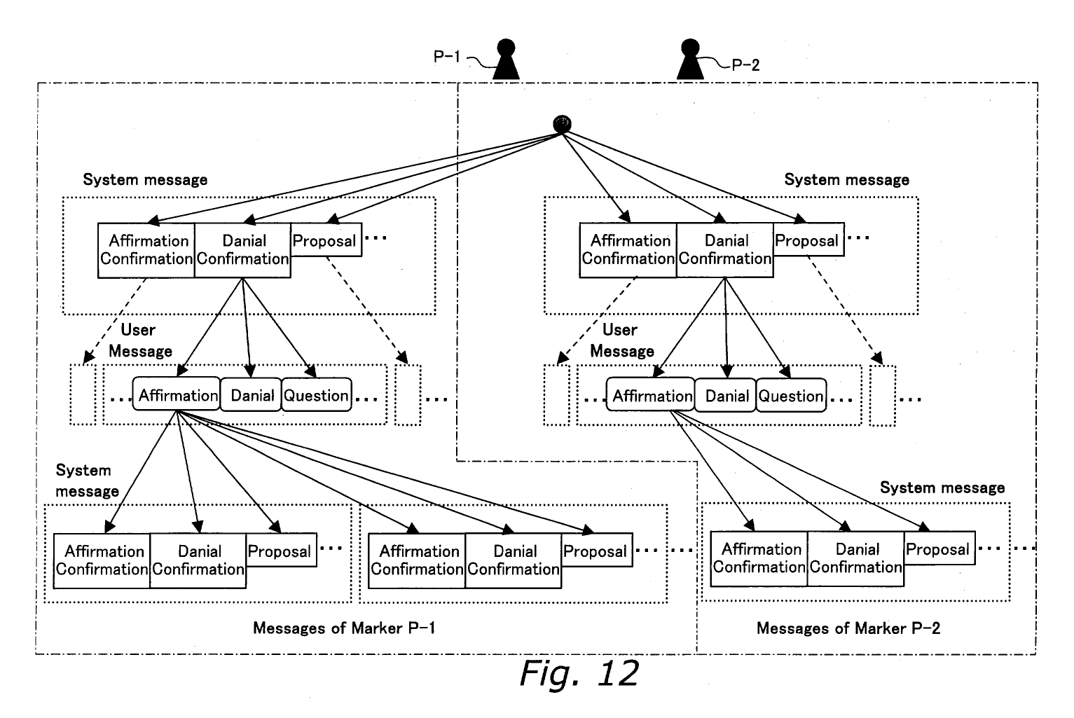

(2-1) Generating Context Patterns FIG. 12 is an explanatory diagram showing how context patterns are generated. Conversation patterns indicate where a current topic is heading. In other words, a context pattern is generated according to the current position of the marker (“current node” hereinafter), and to system messages and user messages for nodes and links that are downstream from the current node. Consequently, the number of context patterns that are generated will vary depending on how many times messages thenceforth are combined. FIG. 12 illustrates context patterns generated by predicting, and creating all possible combinations of, n future messages (n≧2, an integer). In this figure n=3, but the value of n is not particularly limited. If the value of n is too high, the number of context patterns that should be generated increases, causing a heavy load on the computer. If the value of n is too small, the reliability of the context pattern rating results deteriorates. The value of n is chosen taking the structure of the topic net or the purpose of the topic net into consideration. Conversation patterns are generated per each marker. It is preferable that a context pattern consists of suitable combinations of system message types and user message types. This is also effective for decreasing the calculation burden of evaluating context patterns in instances in which many context patterns are generated. Conversation patterns are generated by the messaging module 131 based on a new current node when the marker moves from an old one.

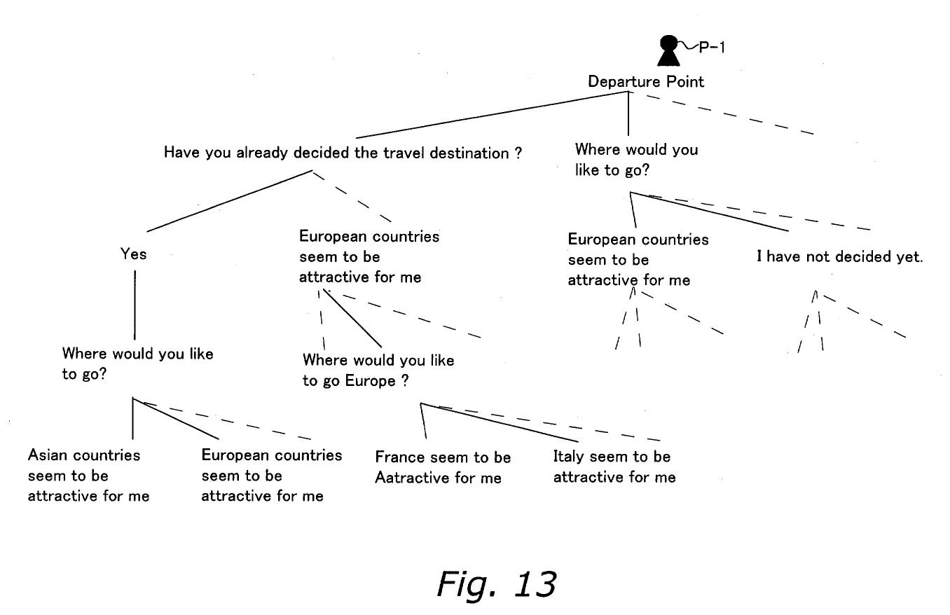

FIG. 13 shows an example of context patterns wherein n is 4. Suppose that the marker is located on the node whose topic is “destination” in the topic net of FIG. 2. In this diagram, context patterns are generated by predicting four future messages based on the current node. The following is one example of a context pattern.

First Conversation Pattern

S1: “Have you already decided on a travel destination?”

U2: “Yes, I have”

S3: “Where would you like to go?”

U4: “Asia sounds attractive to me.”

Here, “S” indicates system messages, and “U” indicates user messages. The number after “S” or “U” indicates the number of the message in succession from the current node.

The following is another example of a context pattern.

Second Conversation Pattern

S1: “Have you already decided on a travel destination?”

U2: “Yes, I have.”

S3: “Where would you like to go to?”

U4: “Europe sounds attractive to me.”

(2-2) Rating Criteria

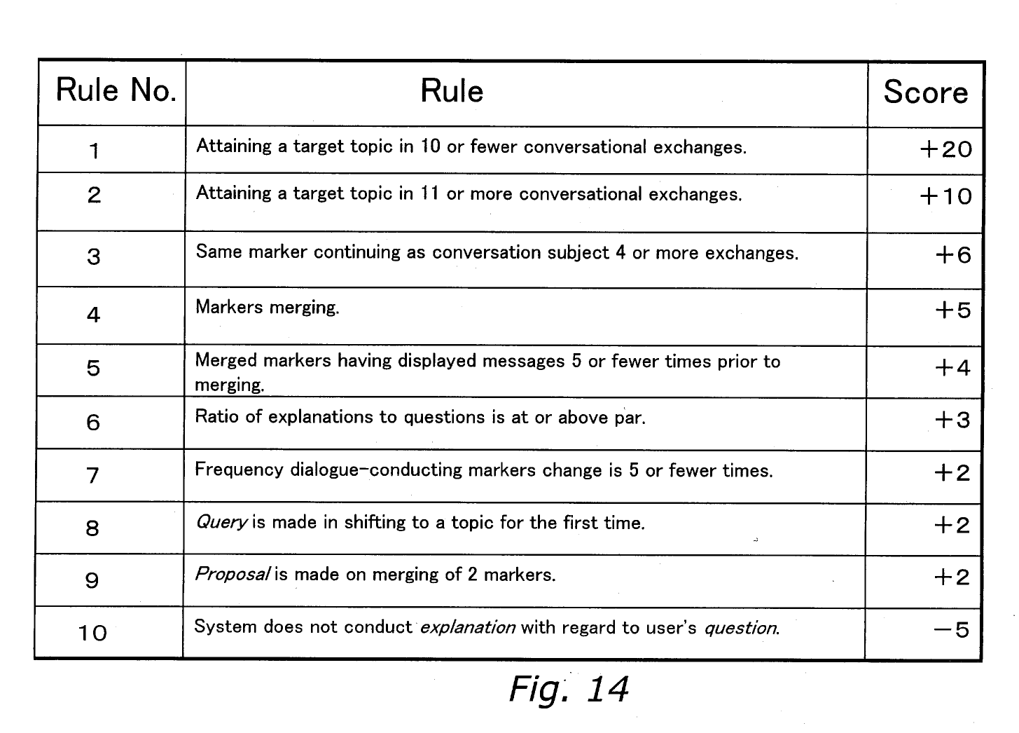

FIG. 14 is an explanatory diagram showing an example of rating criteria stored in the rating criteria DB 12. All generated context patterns are evaluated by the messaging module 131 based on the rating criteria. In FIG. 14, rules indicated by numbers 1 to 10 are established as rating criteria. Each rule is correlated with a score that is given to a context pattern if the context pattern satisfies the rule. A context pattern is evaluated based on the total score, which is the sum of the scores for the rules the context pattern satisfies. These rules will be explained in detail.

Rule No. 1: “If a context pattern including 10 or fewer messages leads to the topic sought, then the context pattern is given a score of 20.” In the present embodiment, if the total number of system messages and user messages is ten or fewer, and moreover the travel destination is decided in the context pattern, then the context pattern is given a score of 20.

Rule No. 2: “If a conversation including 11 or more messages reaches the topic sought, then the context pattern is given a score of 10.” For example, if the total number of system messages and user messages is eleven or more, and moreover the travel destination is decided in the context pattern, then the context pattern is given a score of 10.

Rule No. 3: “If four consecutive messages are displayed based on the same marker, then the context pattern is given a score of 6.” In other words, if a set of conversational exchanges is developed on a topic without changing a subject, then the context pattern is given a score of 6.

Rule No. 4: “If the markers merge into one in a context pattern, then it is given a score of 5.”

Rule No. 5: “If the merged markers correspond to messages displayed five or fewer times prior to merging, then the context pattern is given a score of 4.” In other words, if the merging of markers occurs not long after messages correlating to the markers have been displayed, then the context pattern is given a score of 4.

Rule No. 6: “If the ratio of explanations to questions is at or above a specified par, then the context pattern is given a score of 3.” In other words, if not only enough questions but also explanations are presented to the user in a context pattern, then the context pattern is given a score of 3.

Rule No. 7: “If the number of times conversation-directing markers are changed is five or fewer, then the context pattern is given a score of 2.” In other words, if the conversation-directing markers do not change very often in a subject, then the context pattern is given a score of 2.

Rule No. 8: “If a question to the user is displayed when the subject is new in a context pattern, then the context pattern is given a score of 2.”

Rule No. 9: “If a proposal is displayed when a marker moves to a node on which another marker is located, then the context pattern is given a score of 2.”

Rule No. 10: “If no explanation is displayed in response to a question from the user in a context pattern, then the context pattern is given a score of minus 5.

Not only these rules, but also other rules for appropriately evaluating context patterns may be established as needed.

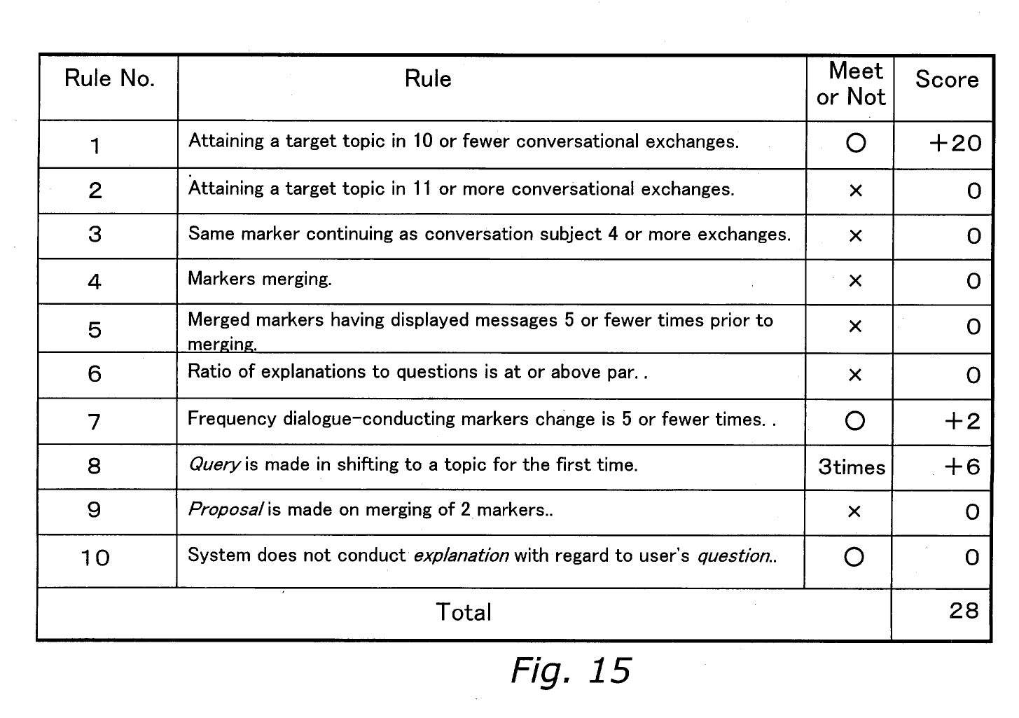

FIG. 15 is an example of a context pattern rating. For each context pattern, whether or not it satisfies each of the rules is judged, and scores from the rules a context pattern satisfies are assigned to the context pattern. The total score for a context pattern is calculated by summing up the scores for the rules that the context pattern satisfies. In this example, the context pattern satisfies Rule Nos. 1, 7, 8 and 10. The total score for the context pattern is 28. All context patterns generated are evaluated likewise.

A system message to be output as a next system message is decided based on the rating results for the context patterns. The next system message may be the next system message from the current node in the context pattern having the highest total score. Alternatively, the next message may be selected by: first, evaluating all context patterns that have been generated; second, grouping all system messages that are possible next messages; third, calculating the average total score for each group; fourth, selecting several groups whose average score is high and selecting the first system messages in the groups. In this case, the number of conversations increases, accompanying which message windows also increase. Selection of context patterns and system messages is executed by the messaging module 131.

At least one user message that corresponds to the selected system message is displayed. The displayed user message will differ according to whether the selected system message is contained in the conversation information for a node or for a link. Selection of the user message is executed by the option outputting module 132.

Referring once more to FIG. 13, further examples of context pattern selection and of message display will be explained. In FIG. 13, if the first context pattern has the highest score, “Have you already decided on a destination?” is selected as the next system message that is to be displayed. The user messages displayed as options in response to this system message are: “Yes, I have”; “Europe sounds attractive to me”; and the like.

Subsequent to the displaying of user messages, the marker(s) are moved according any user message selected; and context pattern generation based on the new current node, evaluation of the context patterns, selection and display of system messages and user messages, and marker(s) movement are executed. These steps are repeated by the iterating module 135, and a conversation based on a topic net develops.

(2-3) Conversation Developing Process

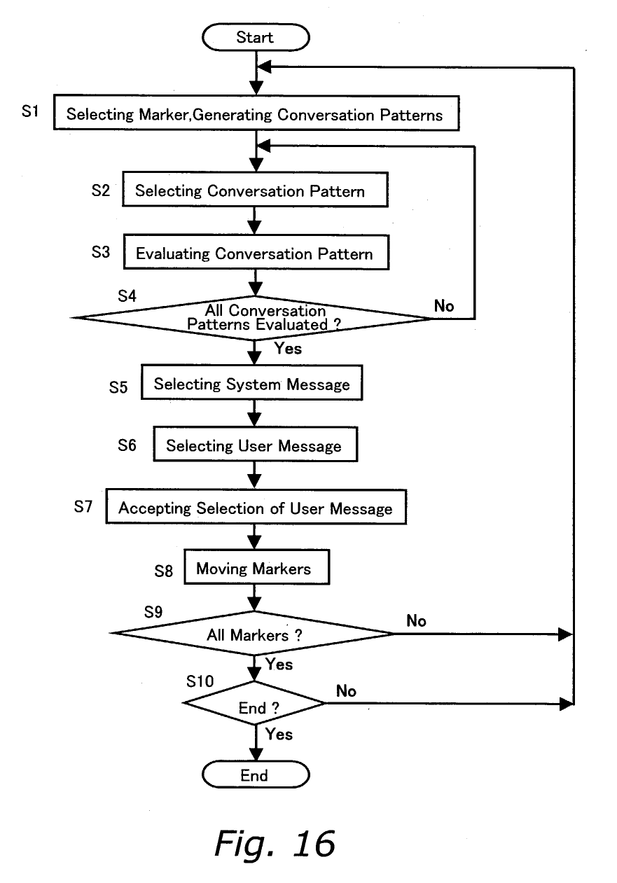

FIG. 16 is a flowchart illustrating flow of a process the control unit 13 carries out for developing conversation.

Step S1: The messaging module 131 in the control unit 13 selects a current marker that will be the marker by which a set of conversational exchanges is developed in the following steps. If the number of markers is one, that marker becomes the current marker. Then, the messaging module 131 creates context patterns based on conversation information for the current node on which the current marker is located, and on conversation information for links and nodes downstream from the current node. These context patterns include n messages leading from the current node.

Step S2: The messaging module 131 selects a context pattern that is to be evaluated in the ensuing steps.

Step S3: The messaging module 131 evaluates the selected context pattern based on the evaluation criteria and calculates the total score.

Step S4: The messaging module 131 determines whether or not evaluations have been made on all the context patterns created. If the determination is “No,” the process flow returns to step S2 and the foregoing process is repeated. If the determination “Yes,” step S5 ensues.

Step S5: The messaging module 131 selects at least one context pattern and selects the first system message included in the selected context pattern. Here, if a plurality of context patterns is selected, a new marker is created by the deciding module 134. Selected system messages are output by the GUI 2 to message windows for each marker.

Step S6: The option outputting module 132 selects according to the system message selected in step S5 at least one user message from conversation information. One way of selecting a user message is, as mentioned in section (1-3), if the system message is selected from conversation information for a node, a user message contained in the conversation information for the node or in links that issue from the node is selected. The selected user message is displayed on the screen by the GUI 2 as an option for responding to the system message.

Step S7: The selection accepting module 133 accepts from the user selection of any of the user messages displayed.

Step S8: The deciding module 134 moves the current marker according to the selected user message.

Step S9: The iterating module 135 determines whether or not the foregoing process has been executed for all markers created. If the determination is “No,” the process flow returns to step S 1, the current marker is changed, and the foregoing steps are executed. If the determination is “Yes,” step S10 ensues.

Step S10: The iterating module 135 determines whether or not the process is finished. That is, the iterating module 135 determines whether or not the marker has reaches a target topic as a result of the conversation. For example, in the topic net of aforementioned FIG. 2, if the marker reaches a node in the furthest downstream-end of the topic net, it is determined that the process is finished. If the determination is “Yes,” the process ends, and if the determination is “No,” it returns to aforementioned step S1. That is, until the conversation objective is attained, the creation of context patterns corresponding to a current node, evaluation of the context patterns, and based on the evaluation result execution of conversations and movement of markers, are repeated.

### SECOND EMBODIMENT EXAMPLE

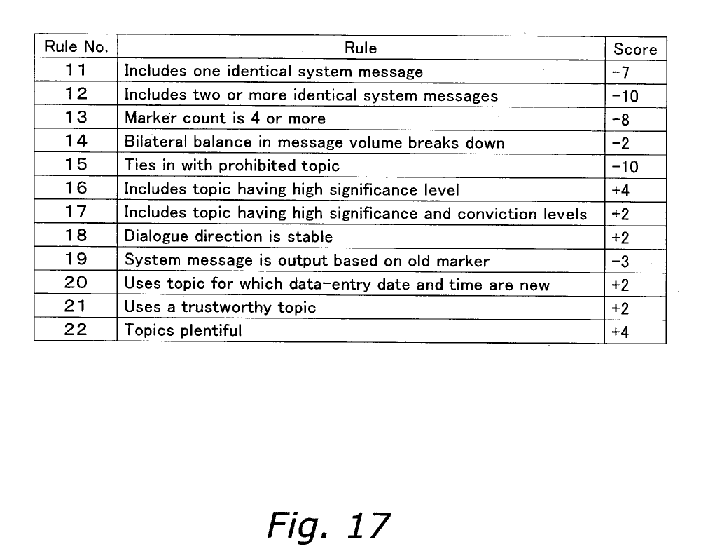

How a conversation is made to proceed from a current node in other words, which of the created conversation patterns is selected—is dependent upon the rating criterion. What sort of rating criteria are used is discretionarily variable according to the objectives for which the topic net is used. To give a specific example, the rules illustrated in FIG. 17 may be used as rating criteria, either together with or independent of the rating-criteria rules put forth in the foregoing first embodiment example.

Likewise, in the present embodiment example, in creating a conversation pattern, in addition to the current node, and to the messages for the links and the nodes that are downstream thereof, message(s) that are upstream of the current node may be used. With the exceptions of changing the method of judging whether a rule in accordance with the rating-criteria rules has been satisfied, and of the way in which the context patterns are created, the functions of the conversation device 1 are in large part likewise as with the first embodiment. Depending on the rating criteria, however, functions that will be described later are added to the conversation device 1.

(1) Rating Criteria

To begin with, other examples of rules used as rating criteria will be explained with reference to FIG. 17.

Rule No. 11: “Same system message is repeated twice.” In particular, the context pattern is given a score of −7 if it contains a single system message that is redundant over one output in a past conversational exchange. This ends in the same questions and comments not being repeated to the user, making it possible to hold natural conversations.

Rule No. 12: “Same system message is repeated thrice or more.” In particular, the context pattern is given a score of −10 if it contains two or more system messages that are redundant over one output in a past conversational exchange. This ends in the same questions and comments not being repeated over and over to the user, making it possible to hold natural conversations.

Rule No. 13: “Marker count is 4 or more.” In particular, in a situation in which fresh markers have been created within the context pattern, the context pattern is given a score of −8 if there turns out to be 4 or more markers altogether. That the markers increase means that the user is dialoguing on multiple subjects. There being too many subjects risks that with the user not by him or herself being able to remember the content of the dialogues on all the subjects, the conversation will end up breaking apart. To address this risk, it is preferable to set an upper limit to the number of dialogues that proceed at once, and to encourage convergence of the dialogues.

Rule No. 14: “Bilateral balance in the volume of messages breaks down.” In particular, in a situation in which the quantity of system messages is too great or, conversely, the quantity of user messages is too great, a score of −2 is conferred on the context pattern. Too great a quantity of system messages leads to passive dialogue for the user, and interest wanes. By the same token, the quantity of information offered to the user turns out to be too little. Striking a balance between the two realizes natural, enjoyable dialogues.

Rule No. 15: “Ties in with prohibited topic.” In particular, a score of −10 is conferred on a context pattern that ties in with a prohibited topic that the user does not wish to touch upon. Avoiding prohibited topics allows dialogues that accord with user preferences to be realized. Prohibited topics might for example be inferred from user messages that a user has selected with respect to given system messages. Likewise for example, a variable may be assigned to each topic within the topic net, and prohibited topics inferred based on those variables. A variable might be, to give an example, a prohibited-topic variable that indicates the extent to which a user does not want to touch on the topic. Significance levels indicating how significant the topics that the nodes on the topic net represent are for a user, and conviction levels indicating how certain the significance levels are may be utilized as prohibited-topic variables.

Rule No. 16: “Includes topic having high significance level.” In a situation, as will be described later, in which a significance level has been established for each node in the topic net, a score of +4 is conferred on a context pattern that includes a topic whose significance level is high. Dialogues that are interesting for a user presumably may be held by outputting system messages that go along with topics that the user feels are important. A significance level might be a value that is designated by a user, or might be an inferred value, wherein a value designated by a user has been conveyed along a link on the topic net.

Rule No. 17: “Includes topic having high significance and conviction levels.” In a situation, as will be described later, in which a significance level and a conviction level have been established for each node in the topic net, a score of +2 is conferred on a context pattern that includes a topic whose significance level and conviction level are high. A conviction level could, for example, be high with respect to a significance level the value for which has been designated by a user, and could be low with respect to a significance level the value for which has been determined by conveyance along a link on the topic net. User interest in topics is presumable high if the significance and conviction levels for the topics are together high. Selecting context patterns including topics of this sort allows dialogues to be conducted along the lines of a user's tastes and interests.

Rule No. 18: “Dialogue direction is stable.” In particular, if the orientation of a dialogue is stable in not frequently switching between the two directions, then a score of +2 is conferred on the context pattern. Supposing for example that links in the topic net indicate generalizing/individualizing directions for the topics, then if a dialogue orientation switches frequently between generalizing and individualizing, there would be a concern that with a poor flow, the dialogue would end up developing insufficiently. Dialogue development can be encouraged by avoiding such context patterns. Whether or not the orientation of a dialogue is stable can be judged according to whether or not the frequency at which switchovers in dialogue direction arise surpasses a threshold value. Here, the orientation of links is expressed as upstream/downstream, generalizing/individualizing, expensive/bargain, etc. depending on the nature of the topic net. Even with such differences in representation as these, those context patterns that are bi-directionally stable are rated with a score of +2.

Rule No. 19: “System message output based on an old marker.” What this rule may be applied to is a topic net for which the aforementioned significance and conviction levels have been established. The date and time the markers are created are stored in the conversation device 1, and markers for which a given time period has elapsed since they were created are deleted from the topic net. Significance and conviction levels for topics in connection with a deleted marker are downgraded. A score of-3 is conferred on context patterns that include topics relating to deleted markers. A score of −3 might be conferred on context patterns wherein the proportion of topics in connection with deleted markers surpasses a given value. Context patterns including topics that relate to new markers are as a result prioritized.

Rule No. 20: “Uses topic for which data-entry date and time are new.” In particular, the date and time that dialogue information is entered is stored in the conversation device 1, and a score of +2 is conferred on a context pattern that includes dialogue information for which the entry date and time are new. That is, a score of +2 is conferred on those context patterns that include dialogue information for which the elapsed time since their data entry dates and times is the shorter. For instance, a score of +2 can be conferred in a situation in which the proportion that is occupied by dialogue information for which the elapsed time exceeds a predetermined value surpasses a given value. Executing context patterns that include new dialogue information makes hot conversations based on fresh information possible.

Rule No. 21: “Uses a trustworthy topic.” In particular, a context pattern that includes topics involving a data enterer whose reliability is believed to be high, or a context pattern for which the proportion of such topics is a certain amount or more, is provided a score of +2. A “data enterer” herein is someone who has inputted dialogue information, or someone who has prepared dialogue information. Supposing for example that “wine,” which has been entered by a certain data enterer A, is included among a group of topics touched upon in past dialogues, then in this case, on a context pattern that includes the separate topic “winery” that data enterer A has entered a score of +2 would be conferred.

This is because it may be presumed that a user would prefer the topics that data enterer A has entered. A further example that may be given would be selecting from among the created context patterns a context pattern containing the topic “wine” in a situation in which data enterer B, who is a world-famous wine authority, has entered part of the dialogue information concerning that topic.

Rule No. 22: “Topics are plentiful.” In particular, a score of +4 is conferred on context patterns in which there is much variation in the system messages. By leading the user in a direction in which system messages are abundant, dialogues rich in changes can be realized.

(2) Context Pattern Creation

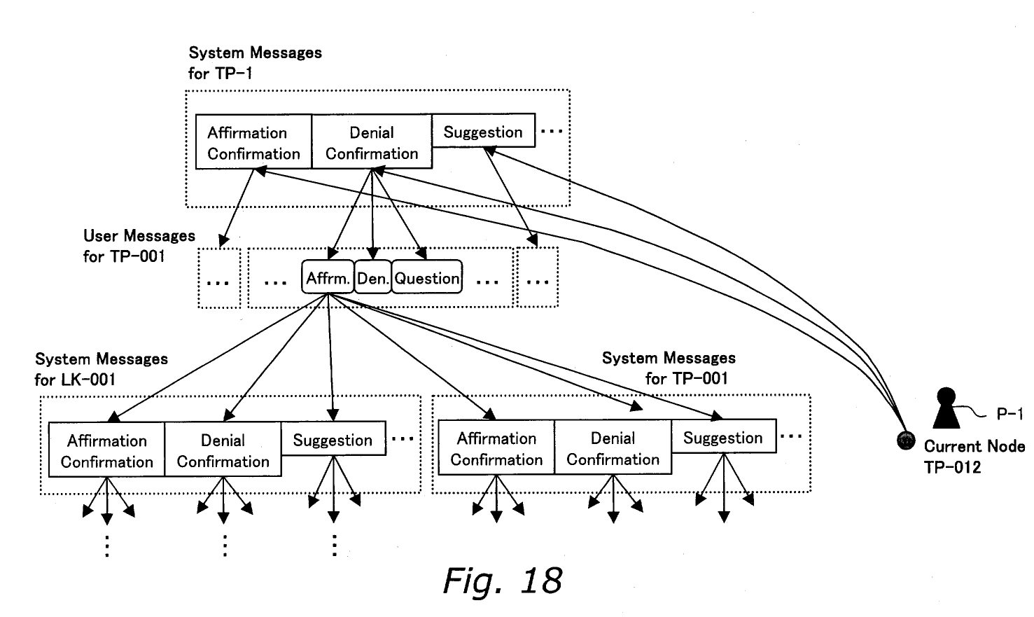

For ease of explanation a situation in which, between two nodes that a link on the topic net links, going one way an upstream direction is indicated, while going the other a downstream direction is, will be taken as an example. The context pattern may contain system messages and user messages for nodes and links that are upstream from the current node, not just for nodes and links that are downstream from the current node. Likewise, the progress direction for a dialogue in the context pattern may be in the upstream direction, not just in the downstream direction. Moreover the dialogue progress direction may switch at least one time into the upstream/downstream direction. FIG. 18 illustrates a context pattern that steers once in the upstream direction and thereafter proceeds in the downstream direction. As described earlier, it is possible to create a context pattern in which switchovers in the upstream/downstream direction take place not just once but a number of times.

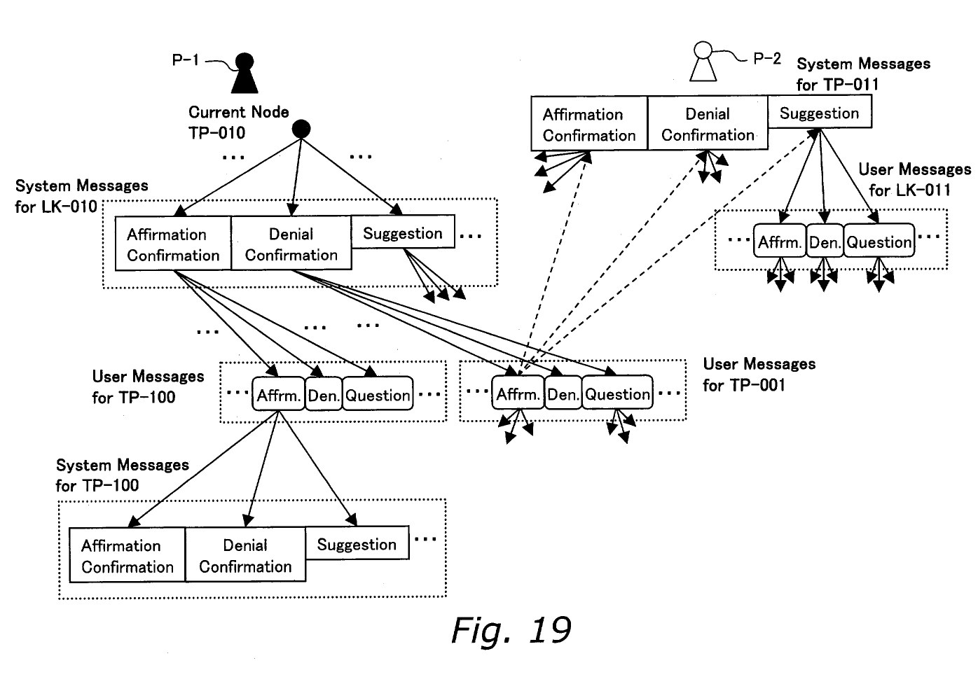

Furthermore, the markers within the context pattern will at times increase. FIG. 19 illustrates a situation in which the markers within one context pattern increase. In this example, an instance in which a single marker is created is shown, but creation of a context pattern that produces two or more markers is possible.

(3) Conversation Device Functions Made Necessary by Rules

As described earlier, there are functions added to the conversation device 1 in accordance with the rules used as rating criteria. An example thereof will be given and explained below.

(3-1) Prohibited-topic variables are assigned to the topics in a situation in which aforementioned Rule No. 15 is applied. If for example a user message that is to avoid a certain topic is selected, the prohibited-topic variable for that topic is set to a comparatively high value. The prohibited-topic variable may also be set according to user-message selection log. For example, if a user message that contradicts the system message, “How does shopping sound?” has been selected, then a prohibited-topic variable for topics relevant to shopping can be set to relatively high value. Likewise, if both shopping and sightseeing together are contradicted, then a prohibited-topic variable for topics pertaining to the two can be set high compared with that for a topic pertaining to any one of the two topics. The prohibited-topic variable can be expressed by a numeral from 0 to 1, or a numeral from 0 to 100, for example.

Likewise, prohibited-topic flags that assume only two values may be utilized in order to facilitate computer processing. For example, if the value of a prohibited-topic flag is “0,” then a conclusion of not being a prohibited topic may be drawn, and if “1,” of being a prohibited topic. The judgment as to whether or not the flag is to be put to “1” is likewise as described earlier.

In a situation in which significance level and conviction level are used in place of prohibited-topic variables, topics for which the value of the significance/conviction level is low presumably may be deemed prohibited topics.

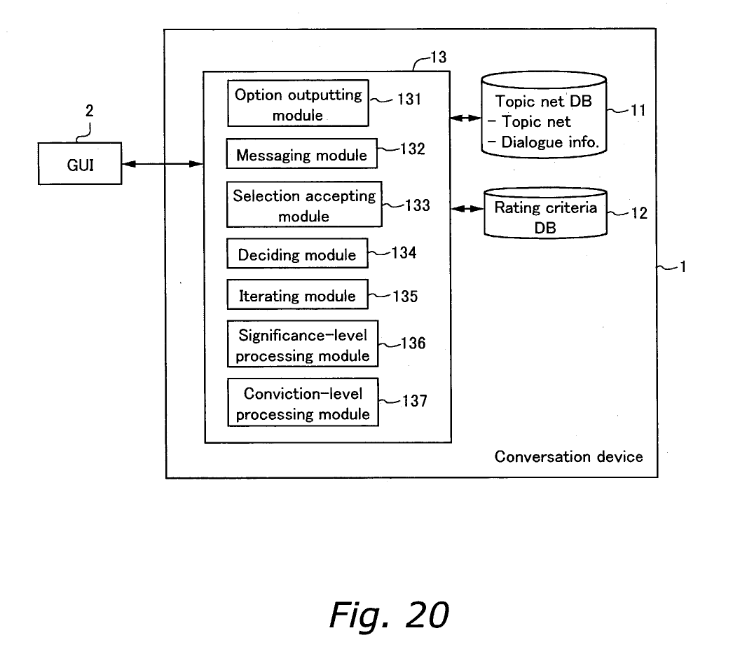

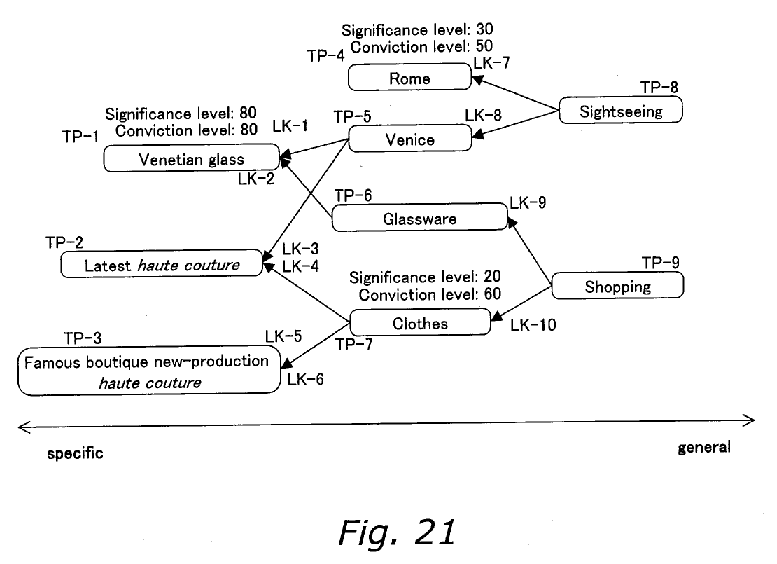

(3-2) In utilizing Rule Nos. 16 and 17, significance and conviction levels are assigned to the topic net. FIG. 20 is a functional block diagram of a conversation device 1 having a function for assigning significance and conviction levels to the topic net. FIG. 21 illustrates an example of a topic net configured with significance levels and conviction levels. It should be understood that a link in this example represents whether two joined nodes are general or are specific relative to each other. By setting significance level with respect to a topic, how important a user regards that topic may be expressed on the topic net. Likewise, by setting conviction level in addition to topic significance level, certainty of the significance level may be expressed in the topic net. The significance and conviction levels may be expressed with numerals such as 0 through 1, or from 0 to 100. In the following, the significance and conviction levels are collectively referred to as needs information, and are expressed with numerals 0 to 100.

Needs information is configured by someone, such as a salesperson, who has a dialogue with a customer inputting each topic utilizing the GUI 2. The significance level and the conviction level with respect to a given topic may be conveyed to another topic. Conveying topic significance levels and topic conviction levels enable significance levels and conviction levels to be configured even with respect to topics for which customer needs information has not been directly input. For conveying significance levels and conviction levels, a number of ways are conceivable.

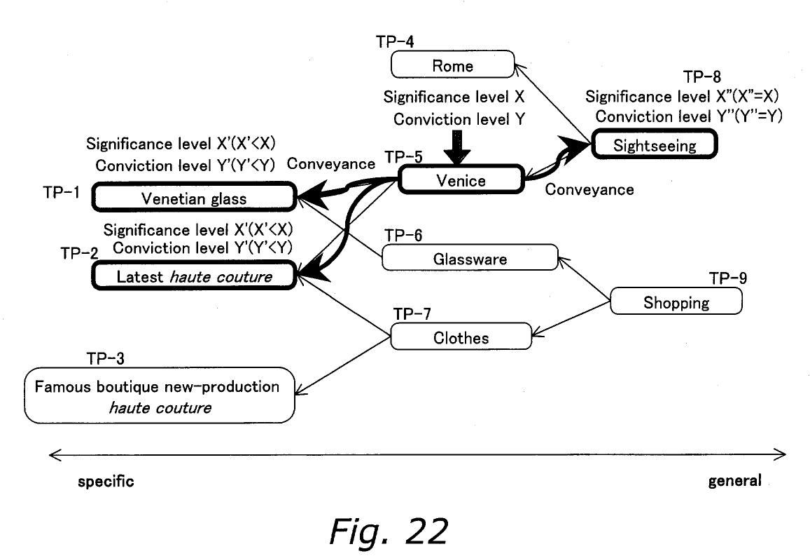

FIG. 22 represents one example of a method for significance-level and conviction-level conveyance. FIG. 22 indicates that setting significance level X and conviction level Y for topic TP-5 “Venice” sets significance level X″ and conviction level Y″ for topic TP-8 “sightseeing” generalizing that topic, identically (X=X″, Y=Y″) with significance level X and conviction level Y for the base topic “Venice”. This is because generalized topic “sightseeing” is a merchandise feature that includes the content of base topic “Venice”. Likewise, FIG. 22 indicates significance level X′ and conviction level Y′ for topics TP-1 “Venetian glass” and TP-2 “latest haute couture” individualizing base topic TP-5 “Venice” being set lower (X′<X, Y′<Y) than significance level X and conviction level Y for base topic “Venice”.

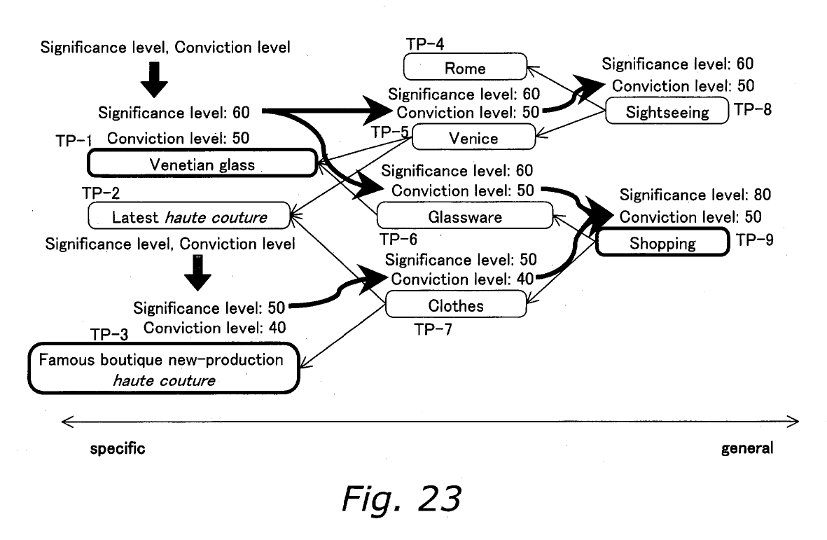

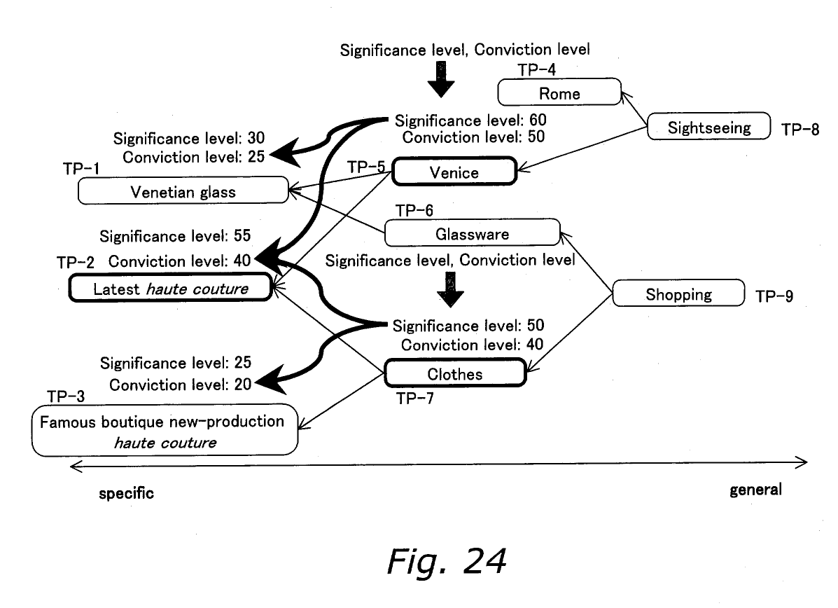

Using FIGS. 23 and 24, the method for significance-level conveyance will be explained in further detail. FIG. 23 indicates the significance level and the conviction level input for a given topic “Venice” being conveyed as it is to all of topics TP-5, TP-6, TP-8 and TP-9, which are more general than topic TP-1 “Venetian glass”. Herein, topics TP-8 “sightseeing” and TP-9 “shopping” are not directly linked with base topic TP-1 “Venetian glass.” However, via topics TP-5 “Venice” and TP-6 “glassware” that are directly linked with topic TP-1 “Venetian glass”, the significance level and the conviction level for topic “Venice” is conveyed as it is to topics TP-8 and TP-9.

Likewise, FIG. 23 indicates conveyed significance levels and conviction levels mutually being superimposed. Where for example significance levels for topic TP-1 “Venetian glass” and topic TP-3 “famous boutique new-production haute couture” have been input, the significance levels for the two are conveyed and superimposed with topic TP-9 “shopping.” As a result, the significance level for topic “shopping” is made higher than those of topics TP-8 “sightseeing” on which superimposition has not been effected. Specifically, where the significance levels “60” and “50” for topics TP-1 “Venetian glass” and TP-3 “famous boutique new-production haute couture” have been input, significance level 60 and significance level 50 are conveyed to topic TP-9 “shopping”. As a result, topic the TP-9 “shopping” significance level becomes a value in which significance levels 60 and 50 are superimposed, and that is higher than both 60 and 50, e.g., 80. Doing so facilitates comprehension by generalizing a customer's wishes from piecemeal information on the customer's needs. In this example, the customer's wish may be assumed to be along the lines of “shopping.” Likewise, as a result of superimposition, among conviction level “50” for the base topic “Venetian glass” and conviction level “40” for the base topic “famous boutique new-production haute couture”, the higher value “50” becomes conviction level for a topic of convey destination. Of course, it may be assigned to a value that is higher than that of the base topic.

Another method that may be given as example of a way to convey significance level and conviction level utilizes formula (1) below to determine significance level X conveyed to a general topic that shares a plurality of specific topics in common.

X=[1−(1−X₁/100)(1−X₂/100)(1−X₃/100) . . . ]×100 (1)

Here, X₁, X₂, X₃, . . . are the respective significance levels for a plurality of specific topics having a general topic in common. For example, in FIG. 23, supposing that significance levels 60 and 50 are respectively input for topic TP-1 “Venetian glass” and topic TP-2 “latest haute couture”, and given that the two topics have general topic TP-5 “Venice” in common, then significance level X₅ for topic TP-5 “Venice” is calculated as follows. A conviction level can be calculated by utilizing the formula similarly.

X₅=[1−(1−60/100)(1−50/100)]×100=80

FIG. 24 represents significance level and conviction level input for a given topic TP-5 “Venice” being depreciated while conveyed to each of topics TP-1 and TP-2 more general than topic TP-5 “Venice”. For example, a significance level of 60 and conviction level of 50 for topic TP-5 “Venice” is depreciated to “30” and “25” respectively by being conveyed to topic TP-1 “Venetian glass”; a significance level of 50 and a conviction level of 40 for topic TP-7 “clothes” is depreciated to “25” and “20” respectively by being conveyed to topic TP-3 “famous boutique new-production haute couture”

Likewise, FIG. 24 represents, in a situation in which significance levels and conviction levels have been set for a plurality of topics, significance levels and conviction levels being superimposed conveyed to a topic in common with and more specific than the plurality. For example, by setting significance levels of 60 for topic TP-5 “Venice,” and significant level of 50 for topic TP-7 “clothes,” the respective significance levels are conveyed to and superimposed on general topic TP-2, “latest haute couture,” that is in common with the two. The superimposition heightens the significance level of topic TP-2 “latest haute couture,” which is, for example, “55”, and highlights the topic's importance. That is, heightening the significance level of a more specific topic that is in common with a topic whose significance level has been input lets the importance of the more specific topic be brought to the fore. A value of conviction levels for a plurality of topics can be also conveyed and superimposed similarly.

Conviction level may be utilized for determining conveyed value of significance level. In particular, significance levels that in FIGS. 23 and 24 are conveyed may be weighted by multiplying by conviction level/100. Specifically, in FIG. 24, wherein the significance level for topic TP-5 “Venice” is 60 and its conviction level is 50, the significance level X₁ for topic TP-1 “Venetian glass” may be calculated as in formula (2) below. Likewise, in cases shown in FIGS. 23 and 24 in which significance levels being conveyed are superimposed, they may be weighted with the conviction levels. Specifically, in FIG. 24, wherein the significance level for topic TP-5 “Venice” is 60 and its conviction level is 50, and the significance level for topic TP-7 “clothes” is 50 and its conviction level is 40, the significance level X₂ for topic TP-2 “latest haute couture” may be calculated as in formula (3) below. While the following formulas are single examples of conveyance and superimposition of significance level, other formulas may be utilized to make the calculations.

X₁=60×50/100 (2)

X₂=(60×50+50×40)/(50+40) (3)

The receipt of significance-level input and the conveyance of significance level described in the foregoing are carried out by a significance processing module 136 in the conversation device 1 illustrated in FIG. 20. Likewise, receipt of conviction-level input and conviction-level conveyance is carried out by a conviction processing module 137 in the conversation device 1 illustrated in FIG. 20.

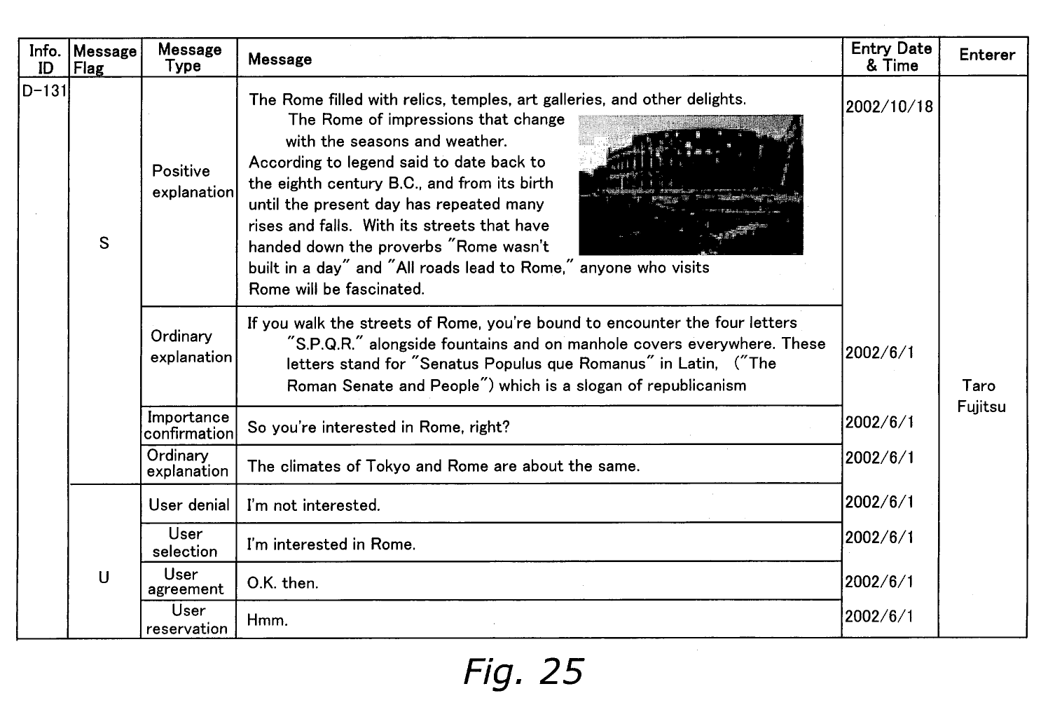

(3-3) Date and time of dialogue-information entry into the topic net DB 11 is stored ahead in the topic net DB 11 in a situation in which aforementioned Rule No. 20 is applied. FIG. 25 sets forth a conceptual explanatory diagram of the topic net DB 11 storing date and time of dialogue-information entry. If the conversation device 1 enables entering and updating dialogue information in message units, the entry date and time are stored message by message. If the conversation device 1 enables entering and updating dialogue information in either topic or link units, the entry date and time are stored topic by topic or link by link.

(3-4) Identifiers for data enterers relating to topics and dialogue information are correlated therewith and stored ahead in the topic net DB 11 in a situation in which aforementioned Rule No. 21 is applied. FIG. 25 sets forth a conceptual explanatory diagram of the topic net DB 11 storing the name of an enterer relating to a topic. The enterer is for example a person who has entered or prepared dialogue information, or is a person who has a connection to a topic. Persons who “have a connection to a topic” might be authorities on or famous persons concerning a topic, or might be persons having a historical, economic or sociological relationship to it.

(4) Example of Applying Rating Criteria

Next a specific example in which rating criteria are applied will be explained. Here, for ease of explanation, a situation in which a context pattern is rated according to some of the rules illustrated in FIG. 17 will be explained in the following, but obviously these rules and rules for the rating criteria in the first embodiment can be combined as needed. Furthermore, that the functions that are necessary in order to utilize the rules are furnished in the conversation device 1 is taken as a given.

(4-1) Applied Example 1

Rules Applied

Rule No. 12: Same comment is repeated three or more times (−10)

Rule No. 13: Marker count is 4 or more (−8)

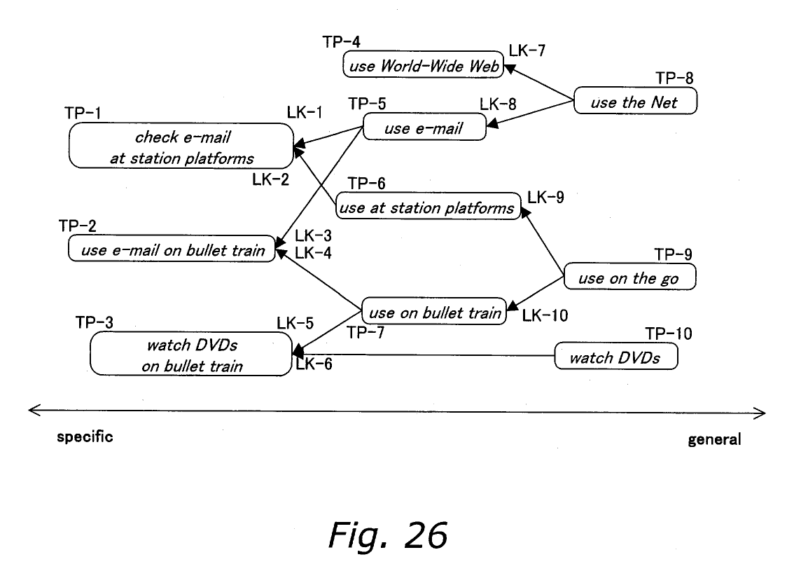

To facilitate explanation, a dialogue in which a personal computer for purchase is decided upon utilizing the topic net of FIG. 26 will be taken as an example. The links in this topic net indicate that one of two topics that are linked is more general than the other. Put oppositely, that one of the topics is more individualized than the other is represented.

Past Dialogue

S01: Welcome. May I help you find something?

U01: I'm looking for a notebook PC.

S02: What type would you like?

U02: Something I could use on the go during business trips would be good.

S03: Any additional preferences?

U03: I'd like to use the Internet.

S04: Any additional preferences?

U04: Being able to watch DVDs would be nice.

According to the dialogue noted above, three markers become positioned respectively on the three topics, “use on the go,” “use the Net,” and “watch DVDs.” The following context patterns 1 and 2 are for instance created as examples of a context pattern developable from the topic “use the Net.” Examples in which a context pattern is created from a message going forward one time are shown herein.

Context Pattern 1

S05: Any additional preferences?

Context Pattern 2

S05: Do you often travel on the bullet train on business trips?

In comparing context patterns 1 and 2 based on Rule Nos. 12 and 13, context pattern 1 is found to include a system message that has been output twice in the past. Likewise, context pattern 1 has produced anew a fourth marker. A total score of −18 is consequently conferred on context pattern 1, and context pattern 2 is selected as a result.

(4-2) Applied Example 2

Rule Applied

Rule No. 22: Topics are plentiful (+4)

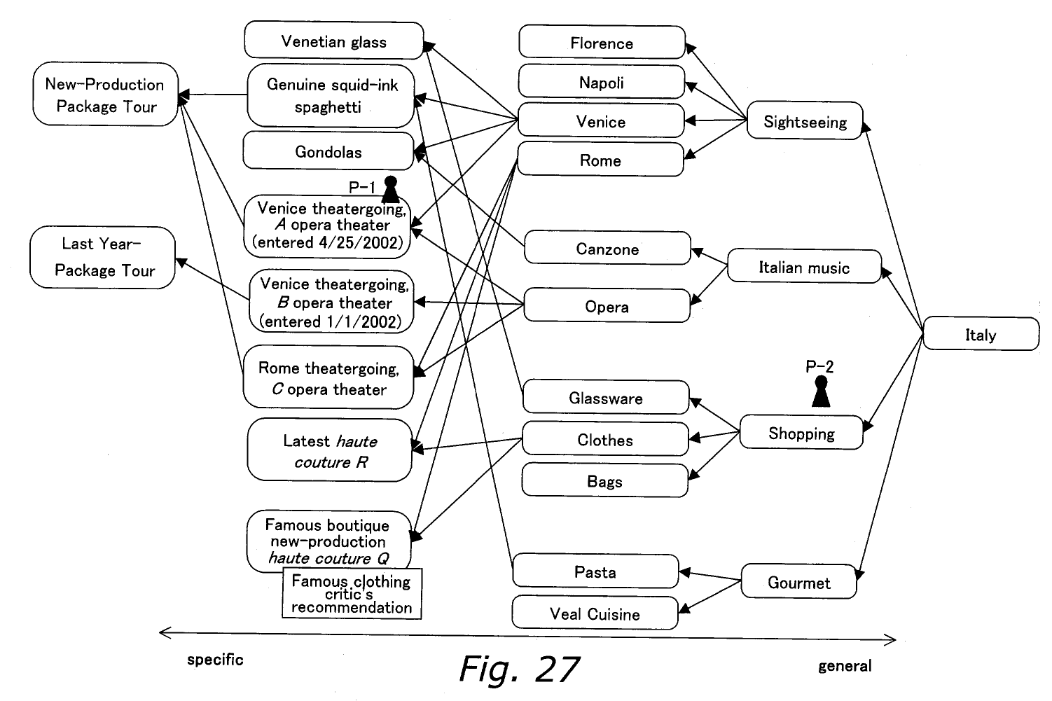

To facilitate explanation, a dialogue in which a travel destination is chosen utilizing the topic net of FIG. 27 will be taken as an example and described. The links in this topic net indicate that a topic on the one hand is more general than on the other. Put oppositely, a link indicates that one of the topics is more individualized than the other.

Past Dialogue

S01: Welcome. How about Europe as a travel destination?

U01: That would be nice.

S02: How about sightseeing in Italy?

U02: That would be nice.

According to the past dialogue noted above, the marker shifts to the node for the topic “sightseeing.” The following context patterns 1 and 2 are created as examples of a context pattern developable from this node.

Context Pattern 1

S03: How does Venice, the historic watercourse town sound?

Context Pattern 2

S03: How does Rome, the city that was the stage for “Roman Holiday” sound?

Comparing context patterns 1 and 2 based on the foregoing Rule No. 22 leads to context pattern 2, which includes the topic “Venice” the links to which are more numerous than to other cites, being selected. Examples in which a context pattern is created from a message going forward one time are shown herein.

(4-3) Applied Example 3

Rules Applied

Rule No. 14: Bilateral balance in the volume of messages breaks down (−2)

Rule No. 15: Ties in with prohibited topic (−10)

To facilitate explanation, it will be assumed that a continuation of the dialogue in the foregoing Applied Example 2 has been conducted as follows, utilizing the topic net of the aforementioned FIG. 27.

Past Dialogue

S01: Welcome. How about Europe as a travel destination?

U01: That would be nice.

S02: How about sightseeing in Italy?

U02: That would be nice.

S03: How does Venice, the historic watercourse town sound?

U03: Sounds good.

S04: How about riding on a gondola in Venice?

U04: Absolutely not. I get queasy on boats.

User message U04 leads to the marker staying positioned on the node for the topic “Venice.”

The following context patterns 1 through 3 are created as examples of a context pattern developable from this node. Examples in which a context pattern is created from messages going forward three times are shown.

Context Pattern 1

S05: Is there anything else you'd like to do in Italy?

U05: I'd like to listen to something Italian in music.

S06: Speaking of Italy, canzones are famous.

Context Pattern 2

S05: Is there anything else you'd like to do in Italy?

U05: I'd like to listen to something Italian in music.

S06: I suggest theatergoing in Italy, where opera was born.

Context Pattern 3

S05: How about the crab cuisine that is a specialty at restaurants?

U05: I'm not interested.

S06: All right, then how about taking in the opera at the A Opera Theater?

At the point in time user message U04 is inputted, the quantity of system messages is considerably greater than the quantity of user messages. To address this and improve the bilateral balance in the messages, a context pattern is selected applying Rule No. 14. Specifically, a context pattern that includes many individualizing open questions through which the quantity of user messages is likely to increase, relative to the slight quantity of user messages through individualizing selective questions, is selected. Furthermore, according to user message U04, riding on a gondola is interpreted as a topic that should not be touched upon. In this respect context patterns apart from those tied in with gondolas are selected.

Rating the aforementioned context patterns 1, 2 and 3 is done as follows. Context pattern 1 is given a score of −10 because while on the one hand it has numerous individualizing open questions, from canzones it ties in to the prohibited topic “gondolas.” Points are not deducted from context pattern 2 because, in addition to not tying in to a prohibited topic, it has numerous individualizing open questions. A score of −2 is conferred on context pattern 3 because although it does not contain prohibited topics, it has numerous individualized selective questions. Context pattern 2 is therefore selected in this case.

(4-4) Applied Example 4

Rules Applied

Rule No. 16: Shifts to topic having high significance level (+4)

Rule No. 17: Shifts to topic having high conviction levels (+2)

Rule No. 20: Uses topic for which data-entry date and time are new (+2)

To facilitate explanation, it will be assumed that a continuation of the dialogue in the foregoing Applied Example 3 has been conducted as follows, utilizing the topic net of the aforementioned FIG. 27. It will also be assumed that the significance and conviction levels for the topics “Venice” and “opera” have risen as a result.

Past Dialogue

S01: Welcome. How about Europe as a travel destination?

U01: That would be nice.

S02: How about sightseeing in Italy?

U02: That would be nice.

S03: How does Venice, the historic watercourse town sound?

U03: Sounds good.

S04: How about riding on a gondola in Venice?

U04: Absolutely not. I get queasy on boats.

S05: Is there anything else you'd like to do in Italy?

U05: I'd like to listen to something Italian in music.

S06: I suggest theatergoing in Italy, where opera was born.

U06: That sounds great.

According to this dialogue, two markers position respectively on two nodes for the topics “Venice” and “opera.” The following context patterns 1 through 3 are created as examples of a context pattern developable from these nodes. Examples in which a context pattern is created from a message going forward one time are shown herein.

Context Pattern 1

S07: You can enjoy really fine opera at the A Opera Theater in Venice.

Context Pattern 2

S07: You can enjoy really fine opera at the B Opera Theater in Venice.

Context Pattern 3

S07: You can enjoy really fine opera at the C Opera Theater in Rome.

The context patterns 1 through 3 are rated as follows according to Rules No. 16 and 17. Context pattern 1 includes both the topics “Venice” and “Opera,” whose significance and conviction levels are together high. Moreover, the detailed data pertaining to A Opera Theater is newer than the detailed data pertaining to B Opera Theater likewise in Venice. A total score of +8 is accordingly conferred on context pattern 1. A score of +6 is meanwhile given to context pattern 2, because it utilizes data older than the renewal date. Finally, context pattern 3 turns out with a low rating value relative to context patterns 1 and 2, because the significance and conviction levels for Rome are low. Context pattern 1 is therefore selected in this case.

(4-5) Applied Example 5

Rules Applied

Rule No. 18: Dialogue direction is stable (+2)

Rule No. 21: Uses a trustworthy topic (+2)

To facilitate explanation, it will be assumed that a context pattern has been created as follows, continuing the dialogue in the foregoing Applied Example 4.

Context Pattern 1

S08: Besides that, Venice can have you enjoying delicious meals.

U08: Uh-hum.

S09: How does squid-ink spaghetti, genuine pasta Italiano, sound?

U09: Squid ink? Well, . . .

S10: Venice is otherwise famous for its variety of fine craftwork.

U10: Oh.

S11: Venetian glass for example is loved by everyone.

Context Pattern 2

S08: Speaking of Italy, you can enjoy a variety of shopping experiences, so how does that sound?

U08: Sounds nice.

S09: What sort of things might you like to shop for?

U09: I'd like to shop for clothes.

S10: In that case how about going to boutique R, world-famous for the latest in haute couture?

U10: That really sounds good.

Context Pattern 3

S08: Speaking of Italy, you can enjoy a variety of shopping experiences, so how does that sound?

U08: Sounds nice.

S09: What sort of things might you like to shop for?

U09: I'd like to shop for clothes.

S10: In that case how about going to see boutique Q, the shop recommended by clothing critic A and celebrated for new work in haute couture?

In context pattern 1 the dialogue flow switches over frequently between the generalizing and individualizing directions. The flow of what is being said is therefore hard for the user to follow, and the conversation fails to build up to anything. Consequently, based on Rule No. 18, no points are conferred on context pattern 1.

With context patterns 2 and 3, new markers are created, and the conversation proceeds according to the markers. Consequently, based on Rule No. 18, a score of +2 is conferred on each. Moreover, context pattern 3 includes the topic about the haute couture boutique Q that is recommended by clothing critic A. Context pattern 3 is for that reason given a further score of +2 according to Rule No. 21. Context pattern 3 is therefore selected in this instance.

(4-6) Applied Example 6

Rating Rule Applied

Rule No. 19: System message output based on an old marker (−3)

To facilitate explanation, it will be assumed that the dialogue of the foregoing Applied Example 5 goes on further, based on the topic net of the aforementioned FIG. 27, and that remarks completely divorced from the remarks about Venice and the opera, which first marker P-1 relates to, have continued for a while. In this case first marker P-1 is deleted, and the significance and conviction levels for topics “Venice” and “opera” are downgraded. Furthermore, dialogue according to second pointer P-2 deadlocks, and when attempting to change the discourse, a context pattern such as the following is for example created.

Context Pattern

S20: By the way, Venice can have you enjoying delicious meals.

This context pattern ends up with an old remark abruptly appearing, which confuses the user. A score of −3 is therefore conferred, based on Rule No. 19, on the above-noted context pattern. Such context patterns accordingly are unlikely to be selected.

### OTHER EMBODIMENT EXAMPLES

(A) In the foregoing first embodiment, searching for merchandise is exemplified, but the present invention can be used in other applications. For example, the invention can be used for a car navigation system. A user inputs a starting point and a destination, and selects what he/she wants to do on the way—such as “visit an art museum,” or “have a meal.” The navigation system outputs system messages based on pre-memorized road maps and embedded information. For example, system messages such as “Fujitsu art museum is located at XYZ. This art museum displays works of Ichiro Fujitsu, the great Japanese painter”; or “How about Restaurant Fujitsu?” are output. The user selects a reply in response to this. With this repetition, a route from the starting point to the destination is determined and navigation carried out according to the route.

(B) The rules applied as rating criteria in the foregoing first and second embodiment examples can be utilized in appropriate combinations according to topic-net application. Likewise, rules not set forth in the foregoing embodiment examples can be utilized as rating criteria according to topic-net application.

(C) The present invention includes programs that realize the foregoing method, as well as computer-readable recording media on which the programs are recorded. As example of recording media herein, flexible discs, hard discs, semiconductor memory, CD-ROMs, DVDs, magneto-optical discs (MOs), and other computer-read/writeable recording media may be cited.

Using the present invention realizes the conducting of conversations in a natural context by a computer and a user who operates it.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A conversation method for conducting conversations between a computer and a user who operates the computer, the conversation method including:
a topic-net storing step of storing a topic net linking a plurality of topics;
a conversation-information storing step of storing conversation information including at least one system message that is a message from the computer, at least one user message that is a message from the user and that corresponds to the system message, and a correspondence between a position in the topic net and the system message and/or the user message;
a messaging step including
a sub-step of creating potential context patterns based upon a position in the topic net of a first marker indicating a current topic in the conversation,
a sub-step of selecting at least one context pattern from the created context patterns, and
a sub-step of selecting a system message based upon the selected context pattern and outputting it;
an option outputting step including
a sub-step of selecting at least one user message based upon the position in the topic net correspondent to the selected system message, and
a sub-step of outputting the selected user message,
a selection accepting step of accepting selection of any one of the selected user messages;
a decision making step of deciding the first marker's next position in the topic net; and
an iterating step of iterating said messaging step, said option outputting step, said selection step and said decision making step.

2. The conversation method set forth by claim 1, wherein a link joining any given first topic and any given second topic within the topic net defines a first direction heading from the first topic to the second topic, and a second direction heading from the second topic to the first topic.

3. The conversation method set forth by claim 1, further including:
a first marker creating step of creating a second marker at any position in the topic net, wherein the second marker is independent of the first marker;
a multi-conversation executing step of executing at least two conversational exchanges on each of the first marker and the second marker, by executing said messaging step, said option outputting step, said selection accepting step, said deciding step, and said iterating step.

4. The conversation method set forth by claim 3, wherein said marker creating step creates the second marker in case two context patterns are selected among the context patterns created in said messaging step, assigns the first marker to one of the context pattern, and assigns the second marker to the other of the context patterns.

5. The conversation method set forth by claim 3, further including a merging step of merging the first marker and the second marker into one marker and merging two conversational exchanges into one conversational exchange if both the markers move to the same position in the topic net.

6. The conversation method set forth by claim 1, further including:
a topic selecting step of accepting selection of at least one topic from the user;
a creating step of creating at least one marker according to the number of topics selected in said topic selecting step;
an executing-conversational exchanges step of executing, for each of the markers created, said messaging step, said option outputting step, said selection accepting step, said decision making step, and said repeating step.

7. The conversation method set forth by claim 1, wherein the conversation information further includes at least one message type indicating a system-message category or a user message category, wherein:
said messaging step creates the context patterns based upon the message types; and
said option outputting step outputs a user message whose message type matches the system message's message type, the user message among user messages corresponding to the system message.

8. The conversation method set forth by claim 1, further including a criterion storing step of storing a rating criterion for evaluating the context patterns; wherein
said messaging step evaluates created context patterns according to the rating criterion and selects at least one context pattern based upon the evaluation results.

9. The conversation method set forth by claim 8, further including a log-storing step of storing a past-outputted system message; wherein
said messaging step evaluates the created context patterns according to the rating criterion, and selects a context pattern for which system messages redundant over past-outputted system messages are few.

10. The conversation method set forth by claim 8, further including:
a second maker creating step of newly creating at least one second marker in any given position on the topic net;
a second multi-conversation executing step of executing, with regard to each of the first marker and the second marker(s), said messaging step, said option outputting step, said election accepting step, said deciding step, and said iterating step; wherein
said messaging step evaluates the created context patterns according to the rating criterion, and among the context patterns selects a context pattern for which its marker total count does not exceed a threshold value.

11. The conversation method set forth by claim 8, wherein said messaging step evaluates the created context patterns according to the rating criterion, and selects a context pattern for which a balance is struck between system-message quantity and user message quantity.

12. The conversation method set forth by claim 8, further including a prohibited-topic assigning step of assigning to a topic within the topic net a prohibited-topic variable indicating that the user does not like said topic; wherein:
said topic-net storing step stores correlatively with said conversation topic the prohibited-topic variable assigned in said prohibited-topic assigning step; and
said messaging step rates the created context patterns according to the rating criterion, and selects a context pattern not containing the prohibited topic being said topic the user does not like.

13. The conversation method set forth by claim 8, further including a significance-level assigning step of assigning, correlatively to the topics in the topic net, significance levels indicating how important the user views each of the topics in the topic net as being; wherein:
said conversation-information storing step further stores, correlatively with the topics, the significance levels assigned in said significance-level assigning step; and
said messaging step selects a context pattern based on the significance levels for the topics contained in the created context patterns, and on the rating criterion.

14. The conversation method set forth by claim 8, further including a variable-assigning step of assigning, correlatively to the topics within the topic net, significance levels indicating how important the user views each of the topics in the topic net as being, and conviction levels indicating how certain are the significance levels; wherein:
said conversation-information storing step further stores, correlatively with the topics, the significance levels and conviction levels assigned in said variable-assigning step; and
said messaging step selects a context pattern based on the significance and conviction levels for the topics contained in the created context patterns, and on the rating criterion.

15. The conversation method set forth by claim 14, further including:
a second marker creating step of newly creating at least one second marker in any given position on the topic net;
an updating step of monitoring elapsed time since creation of the markers and deleting markers for which a given amount of time has elapsed, and updating the significance levels and/or conviction levels for topics relevant to the deleted markers, or else without deleting markers for which a given amount of time has elapsed, updating the significance levels and/or conviction levels for topics relevant to said markers; and
a second multi-conversation executing step of executing, with regard to those remaining of either the first marker or the second marker(s), said messaging step, said option outputting step, said selection accepting step, said deciding step, and said iterating step; wherein
said messaging step selects a context pattern based on the significance and conviction levels for the topics contained in the created context patterns, and on the rating criterion.

16. The conversation method set forth by claim 8, wherein:
a link joining any given first topic and any given second topic within the topic net indicates a first direction heading from the first topic to the second topic, and a second direction heading from the second topic to the first topic; and
said messaging step evaluates the created context patterns according to the rating criterion, and selects a context pattern for which the movement of the first marker does not frequently, at a predetermined rate or more, switch over between the first direction and the second direction.

17. The conversation method set forth by claim 8:
said conversation-information storing step further storing date and time the conversation information was correlated with the topic net;
further including an elapsed-time computation step of timing the current date and time, and computing time elapsed from the stored date and time to the current date and time; wherein
said messaging step rates the created context patterns according to the rating criterion, and selects a context pattern containing a topic correlated with conversation information for which the elapsed time is the shorter.

18. The conversation method set forth by claim 8, wherein said messaging step rates the created context patterns according to the rating criterion, and selects a context pattern for which the number of system messages included in said context pattern is the greater.

19. The conversation method set forth by claim 8, wherein said messaging step creates context patterns made up of system messages and user messages, wherein system-message and user-message total count is a predetermined number or more.

20. A conversation device utilized for a computer and performing conversation between the computer and a user who operates it, the conversation device comprises:
a topic net storing means for storing a topic net linking a plurality of topics;
a conversation information storing means for storing conversation information including at least one system message that is a message from the computer, at least one user message that is a message from the user and that corresponds to the system message, and a correspondence between a position in the topic net and the system message and/or the user message;
a messaging means for creating potential context patterns based upon a position in the topic net of a first marker indicating a current topic in the conversation, selecting at least one context pattern from the created context patterns, and selecting a system message based upon the selected context pattern and outputting it
an option outputting means for selecting at least one user message based upon the position in the topic net correspondent to the selected system message, and outputting the selecting user message;
a selection accepting means for accepting selection of any one of the selected user message;
a decision making means for deciding the first marker's next position in the topic net;
an iterating means for causing said messaging means, said option outputting means, said selection means and said decision making means to execute their functions repeatedly.

21. A program for making a computer function as:
a topic net storing means for storing a topic net linking a plurality of topics;
a conversation information storing means for storing conversation information including at least one system message that is a message from the computer, at least one user message that is a message from the user and that corresponds to the system message, and a correspondence between a position in the topic net and the system message and/or the user message;
a messaging means for creating potential context patterns based upon a position in the topic net of a first marker indicating a current topic in the conversation, selecting at least one context pattern from the created context patterns, and selecting a system message based upon the selected context pattern and outputting it
an option outputting means for selecting at least one user message based upon the position in the topic net correspondent to the selected system message, and outputting the selecting user message;
a selection accepting means for accepting selection of any one of the selected user message;
a decision making means for deciding the first marker's next position in the topic net;
an iterating means for causing said messaging means, said option outputting means, said selection means and said decision making means to execute their functions repeatedly.

22. A computer-readable recording medium on which is recorded a conversation program executing conversation between a computer and a user who operates it, the conversation program executes:
a topic-net storing step of storing a topic net linking a plurality of topics;
a conversation-information storing step of storing conversation information including at least one system message that is a message from the computer, at least one user message that is a message from the user and that corresponds to the system message, and a correspondence between a position in the topic net and the system message and/or the user message;
a messaging step including
a sub-step of creating potential context patterns based upon a position in the topic net of a first marker indicating a current topic in the conversation,
a sub-step of selecting at least one context pattern from the created context patterns, and
a sub-step of selecting a system message based upon the selected context pattern and outputting it;
an option outputting step including
a sub-step of selecting at least one user message based upon the position in the topic net correspondent to the selected system message, and
a sub-step of outputting the selected user message,
a selection accepting step of accepting selection of any one of the selected user messages;
a decision making step of deciding the first marker's next position in the topic net; and
an iterating step of iterating said messaging step, said option outputting step, said selection step and said decision making step.
